(19) United States
(12) Patent Application Publication
(10) Pub. No.: US 2014/0101546 A1
(43) Pub. Date: Apr. 10, 2014

(54) SUPPORTED APPARATUS, SUPPORTING APPARATUS, INTER-APPARATUS GUIDE SYSTEM, RECORDING MEDIUM, AND INTEGRATED CIRCUIT

(71) Applicants: Yuki Taoka, Kyoto (JP); Takao Adachi, Hyogo (JP)

(72) Inventors: Yuki Taoka, Kyoto (JP); Takao Adachi, Hyogo (JP)

(21) Appl. No.: 14/122,334

(22) PCT Filed: May 31, 2012
(86) PCT No.: PCT/JP2012/003570

§ 371 Date: Nov. 26, 2013

(30) Foreign Application Priority Data
Jun. 7, 2011 (JP) 2011-127666

(51) Int. Cl. G06F 3/0481

(52) U.S. Cl. CPC G06F 3/0481
USPC 715/708

(57) ABSTRACT

A supported apparatus includes: an output unit that displays an operation screen which is an image including one or more operation items in the supported apparatus; a request issuance unit that issues a support start request which is a signal including operation screen information for specifying the one or more operation items displayed on the operation screen; a transmission and reception unit that transmits the support start request to a supporting apparatus, and receives guide graphical user interface (GUI) information from the supporting apparatus, the guide GUI information indicating an operation item to be operated by a supported user from among the one or more operation items; and a guide GUI superimposition unit that superimposes a guide GUI on the operation screen based on the guide GUI information, the guide GUI being an image for showing the supported user the operation item to be operated.

### TECHNICAL FIELD

The present invention relates to a supported apparatus and the like, and in particular relates to a supported apparatus and the like in an inter-apparatus guide system in which a supported user who operates a supported apparatus is supported by a supporting user through a supporting apparatus that is connected to the supported apparatus via a network.

### BACKGROUND ART

High-end terminals for individual users, such as smartphones and tablet terminals, have been widely used in recent years. These terminals include platforms such as Android® and iOS, which create environments where various applications are downloaded and executed. Thus, the terminals have become increasingly sophisticated and complex, and have been updated with new features in increasingly shorter cycles.

This causes difficulties for users who are unaccustomed to operate home appliances (users with low IT literacy), e.g. elderly people, to learn how to use new features.

Conventional techniques for supporting the operation of an apparatus from another apparatus include, for example, Remote Desktop included in Microsoft's operating systems and the technique described in Patent Literature (PTL) 1.

Remote Desktop provides a mechanism in which a supported apparatus is operated from a remote PC which is a supporting apparatus, to execute a process.

The technique described in PTL 1 provides a mechanism in which video for operating an application is recorded in a supporting apparatus and transmitted to a supported apparatus.

### CITATION LIST

### Patent Literature

[PTL 1]
Japanese Unexamined Patent Application Publication No. 2009-289098

### SUMMARY OF INVENTION

### Technical Problem

However, the operation support by the conventional techniques has the following problems.

In Remote Desktop, the remote supporting apparatus operates the supported apparatus to execute the process. This causes a problem that a user unaccustomed to operate home appliances is deprived of opportunities to learn how to operate the apparatus.

The present invention solves the conventional problems, and has an object of providing a supported apparatus and the like that enable a supported user to receive interactive operation support from a supporting user without being deprived of learning opportunities.

### Solution to Problem

A supported apparatus according to an aspect of the present invention is a supported apparatus in an inter-apparatus guide system in which a supported user who operates the supported apparatus is supported by a supporting user through a supporting apparatus that is connected to the supported apparatus via a network, the supported apparatus including: an output unit that displays an operation screen which is an image including one or more operation items in the supported apparatus; a request issuance unit that issues a support start request which is a signal including operation screen information for specifying the one or more operation items displayed on the operation screen; a transmission and reception unit that transmits the support start request to the supporting apparatus, and receives guide graphical user interface (GUI) information from the supporting apparatus, the guide GUI information indicating an operation item to be operated by the supported user from among the one or more operation items; and a guide GUI superimposition unit that superimposes a guide GUI on the operation screen based on the guide GUI information, the guide GUI being an image for showing the supported user the operation item to be operated.

Note that the present invention may be realized not only as such a supported apparatus, but also as a support reception method including steps corresponding to the characteristic units included in the supported apparatus, or a program causing a computer to execute these characteristic steps. The program may be distributed via a recording medium such as a CD-ROM (Compact Disc Read Only Memory) or a transmission medium such as the Internet.

The present invention may also be realized as a semiconductor integrated circuit (LSI) that implements part or all of the functions of the supported apparatus, or an inter-apparatus guide system including the supported apparatus and the supporting apparatus.

### Advantageous Effects of Invention

According to the present invention, it is possible to provide a supported apparatus and the like that enable a supported user to receive interactive operation support from a supporting user without being deprived of learning opportunities.

### BRIEF DESCRIPTION OF DRAWINGS

FIG. 1 is a functional block diagram showing an example of structures of a supported apparatus and a supporting apparatus included in an inter-apparatus guide system in an embodiment of the present invention.

FIG. 2 is a schematic diagram showing a first structure of the inter-apparatus guide system in the embodiment of the present invention.

FIG. 3 is a schematic diagram showing a second structure of the inter-apparatus guide system in the embodiment of the present invention.

FIG. 4 is a schematic diagram showing a third structure of the inter-apparatus guide system in the embodiment of the present invention.

FIG. 5 is a diagram showing an example of transition of an operation screen displayed on the supported apparatus in the embodiment of the present invention.

FIG. 6 is a diagram showing an example of a screen in which a guide GUI is superimposed on an operation screen displayed on an input and output unit in the supported apparatus by a guide GUI superimposition unit in the embodiment of the present invention.

FIG. 7 is a diagram showing an example of a guide screen generated by a guide screen generation unit in the embodiment of the present invention.

FIG. 8 is a sequence diagram between the supported apparatus and the supporting apparatus in a guide mode in the embodiment of the present invention.

FIG. 9 is a detailed flowchart of a process of transmitting a support start request to the supporting apparatus in the embodiment of the present invention.

FIG. 10 is a detailed flowchart of a process of superimposing a guide GUI by the supported apparatus in the embodiment of the present invention.

FIG. 11 is a detailed flowchart of a process of making a support continuation request from the supported apparatus to the supporting apparatus in the embodiment of the present invention.

FIG. 12 is a detailed flowchart of a process of drawing a guide screen by the supporting apparatus in the embodiment of the present invention.

FIG. 13 is a detailed flowchart of a process of transmitting guide GUI information from the supporting apparatus to the supported apparatus in the embodiment of the present invention.

FIG. 14 is a sequence diagram between the supported apparatus and the supporting apparatus in a substitute operation mode in the embodiment of the present invention.

FIG. 15 is a detailed flowchart of a process of transmitting a support start request from the supported apparatus to the supporting apparatus in the embodiment of the present invention.

FIG. 16 is a detailed flowchart of a process of recording substitute operation history information by a substitute history recording unit in the supported apparatus in the embodiment of the present invention.

FIG. 17 is a detailed flowchart of a process of displaying a substitute operation screen in the supporting apparatus in the embodiment of the present invention.

FIG. 18 is a detailed flowchart of a process of transmitting substitute operation history information from the supporting apparatus to the supported apparatus in the embodiment of the present invention.

FIG. 19 is a block diagram showing a hardware structure of a computer system that realizes the supported apparatus and the like in the embodiment of the present invention.

### DESCRIPTION OF EMBODIMENTS

### [Underlying Knowledge Forming Basis of the Present Invention]

The method described in PTL 1 which is one of the conventional techniques has the following first problem. Operation video is transmitted from the supporting apparatus to the supported apparatus beforehand, without bidirectional communication. This fails to provide communication-based step-by-step operation learning support where the supported user of the supported apparatus and the supporting user of the supporting apparatus interact with each other to perform operation while checking an operation screen in real time.

The method described in PTL 1 also has the following second problem. Video information of the operation screen needs to be transferred from the supporting apparatus to the supported apparatus. In the case where there is a difference in specifications, such as screen resolution, size of operation components including icons, and arrangement of icons, between the display devices included in the supporting apparatus and the supported apparatus, it is impossible to guide the supported user on an operation component basis.

To solve the first problem stated above, a supported apparatus according to an aspect of the present invention is a supported apparatus in an inter-apparatus guide system in which a supported user who operates the supported apparatus is supported by a supporting user through a supporting apparatus that is connected to the supported apparatus via a network, the supported apparatus including: an output unit that displays an operation screen which is an image including one or more operation items in the supported apparatus; a request issuance unit that issues a support start request which is a signal including operation screen information for specifying the one or more operation items displayed on the operation screen; a transmission and reception unit that transmits the support start request to the supporting apparatus, and receives guide graphical user interface (GUI) information from the supporting apparatus, the guide GUI information indicating an operation item to be operated by the supported user from among the one or more operation items; and a guide GUI superimposition unit that superimposes a guide GUI on the operation screen based on the guide GUI information, the guide GUI being an image for showing the supported user the operation item to be operated.

With this structure, the supported user can learn how to operate the supported apparatus from the supporting user, through the guide GUI displayed on the operation screen. That is, by sharing the operation items between the supporting apparatus used by the supporting user and the supported apparatus used by the supported user and also employing the guide GUI as a resource for sending a remote instruction from the supporting user to the supported user, interaction understandable by the supported user can be achieved between the supporting user and the supported user. This enables the supported user to receive interactive operation support from the supporting user, without being deprived of learning opportunities. Here, the supported apparatus and the supporting apparatus share only the information set beforehand to specify the operation items included in the screen, such as the identifiers of the operation items, instead of sharing the whole screen as an image. Thus, the operation items can be shared between the supported user and the supporting user, regardless of the display devices included in the supporting apparatus and the supported apparatus.

For example, the guide GUI superimposition unit may, in the case where the guide GUI information includes a plurality of operation items and information for specifying an operation sequence of the plurality of operation items, superimpose a guide GUI corresponding to each of the plurality of operation items on the operation screen together with an image indicating an ordinal position of the corresponding operation item in the operation sequence.

With this structure, the supported apparatus outputs the guide GUI together with the operation sequence by superimposing them on the operation screen displayed on the supported apparatus, so that the supported user can be shown the operation item corresponding to the guide GUI information.

For example, the guide GUI information may indicate the operation item operated by the supporting user on a guide screen displayed on the supporting apparatus.

With this structure, the operation item operated by the supporting user can be set as the operation item to be operated by the supported user.

For example, the supported apparatus may further include a process determination unit that receives a support request from the supported user, wherein the process determination unit determines a type of a mode of operation support designated by the supported user when receiving the support request from the supported user and, in the case where the type of the mode is determined as a first mode and the transmission and reception unit receives the guide GUI information, causes the guide GUI superimposition unit to superimpose the guide GUI on the operation screen, and the request issuance unit issues the support start request including the operation screen information and information indicating the determined type of the mode.

With this structure, the supported user can select the mode of operation support. Hence, the supported user can select a desired mode from operation support modes set beforehand, and receive operation support in the selected mode.

For example, the supported apparatus may further include a substitute history recording unit that records substitute operation history information which is history information of an operation performed by the supporting user on the operation item displayed on the supporting apparatus, wherein the process determination unit, in the case where the type of the mode is determined as a second mode different from the first mode, causes the substitute history recording unit to record the substitute operation history information obtained from the supporting apparatus and the operation screen in association with each other.

With this structure, the supported user can select the second mode different from the first mode, as the mode of operation support. In detail, in the second mode, the supported user requests the supporting user to perform all of the operation on the operation target apparatus, and later looks at the operation. The supported user can thus learn the method of operating the operation target apparatus by the supporting apparatus.

For example, the supported apparatus may further include an operation execution unit that transmits an operation signal for operating an external operation target apparatus, to the operation target apparatus, wherein the process determination unit: causes the operation execution unit to transmit, to the operation target apparatus, the operation signal corresponding to the operation performed by the supported user on the operation screen; updates the operation screen to conform to a result of a process executed by the operation target apparatus according to the operation signal; and causes the transmission and reception unit to transmit, to the supporting apparatus, the operation screen information indicating one or more operation items included in the updated operation screen.

For example, the process determination unit may cause the guide GUI superimposition unit to stop superimposing the guide GUI, at least one of: when a predetermined operation is performed by the supported user; when a predetermined signal is received from the operation target apparatus; when a predetermined signal is received from the supporting apparatus; and when a predetermined time elapses.

With this structure, during the operation support in the first mode, the process determination unit can stop the operation support at an appropriate time.

A supporting apparatus according to another aspect of the present invention is a supporting apparatus in an inter-apparatus guide system in which a supported user who operates a supported apparatus is supported by a supporting user through the supporting apparatus that is connected to the supported apparatus via a network, the supporting apparatus including: a transmission and reception unit that receives operation screen information for specifying one or more operation items in the supported apparatus, from the supported apparatus; a guide screen generation unit that generates a guide screen based on the operation screen information, the guide screen being an image including the one or more operation items; an output unit that displays the guide screen; an input unit that obtains an operation performed by the supporting user on the guide screen; and a guide GUI generation unit that generates guide graphical user interface (GUI) information indicating an operation item operated by the supporting user on the guide screen, wherein the transmission and reception unit transmits the guide GUI information to the supported apparatus.

With this structure, the supporting user can transmit, to the supported apparatus, the guide GUI information for specifying the operation item to be operated, by operating the operation item included in the guide screen displayed on the supporting apparatus.

For example, the supporting apparatus may further include: a request reception unit that determines a type of the mode based on information included in the support start request and, in the case where the type of the mode is determined as a first mode, causes the guide screen generation unit to generate the guide screen; and a process determination unit that causes the guide GUI generation unit to generate the guide GUI information, in the case where the type of the mode is determined as the first mode.

With this structure, the supporting apparatus can change the support method according to the selection of the mode of operation support by the supported user.

For example, the supporting apparatus may further include: a substitute screen generation unit that generates a substitute screen which is an image corresponding to an operation screen in the supported apparatus, based on the operation screen information for specifying the one or more operation items displayed on the operation screen in the supported apparatus; a substitute history generation unit that generates substitute operation history information which is history information of an operation performed by the supporting user on the substitute screen; and a substitute operation execution unit that transmits an operation signal for operating an external operation target apparatus, to the operation target apparatus, wherein the request reception unit causes the substitute screen generation unit to generate the substitute screen, in the case where the type of the mode is determined as a second mode different from the first mode, the process determination unit causes the substitute operation execution unit to transmit, to the operation target apparatus, the operation signal corresponding to the operation performed by the supporting user on the substitute screen, in the case where the type of the mode is determined as the second mode, and the substitute operation execution unit causes the substitute history generation unit to generate the substitute operation history information and causes the transmission and reception unit to transmit the substitute operation history information to the supported apparatus, in the case where the type of the mode is determined as the second mode.

With this structure, in the case where the second operation mode is selected, the supporting apparatus generates the substitute operation history information and transmits the substitute operation history information to the supported apparatus. Therefore, in the second operation mode, the supported user can later learn the operation method from the operation history by the supporting user.

An inter-apparatus guide system according to another aspect of the present invention is an inter-apparatus guide system in which a supported user who operates a supported apparatus to operate an operation target apparatus from the supported apparatus is supported by a supporting user through a supporting apparatus that is connected to the supported apparatus via a network, the inter-apparatus guide system including: an output unit in the supported apparatus that displays an operation screen which is an image including one or more operation items in the supported apparatus; a request issuance unit in the supported apparatus that issues a support start request which is a signal including operation screen information for specifying the one or more operation items displayed on the operation screen; a transmission unit in the supported apparatus that transmits the support start request to the supporting apparatus; a reception unit in the supporting apparatus that receives the operation screen information from the supported apparatus; a guide screen generation unit in the supporting apparatus that generates a guide screen based on the operation screen information, the guide screen being an image including the one or more operation items; an output unit in the supporting apparatus that displays the guide screen; an input unit in the supporting apparatus that obtains an operation performed by the supporting user on the guide screen; a guide GUI generation unit in the supporting apparatus that generates guide graphical user interface (GUI) information indicating an operation item operated by the supporting user on the guide screen; a transmission unit in the supporting apparatus that transmits the guide GUI information to the supported apparatus; a reception unit in the supported apparatus that receives the guide GUI information; and a guide GUI superimposition unit in the supported apparatus that superimposes a guide GUI on the operation screen based on the guide GUI information, the guide GUI being an image for showing the supported user the operation item to be operated.

For example, the information for specifying the one or more operation items may be an identifier for identifying an image including each of the one or more operation items, wherein the output unit in the supported apparatus displays a first image identified by the identifier from among one or more images held in the supported apparatus, on the operation screen as the image including the operation item, and the output unit in the supporting apparatus displays a second image identified by the identifier from among one or more images held in the supporting apparatus, on the guide screen as the image including the operation item.

With this structure, the image held in the supported apparatus and the image held in the supporting apparatus are displayed on their respective display screens. This enables interactive operation support regardless of the display devices. The second problem stated above can be solved in this way.

A support reception method according to another aspect of the present invention is a support reception method performed by a supported apparatus in an inter-apparatus guide system in which a supported user who operates the supported apparatus is supported by a supporting user through a supporting apparatus that is connected to the supported apparatus via a network, the support reception method including: displaying an operation screen including one or more operation items, on the supported apparatus; issuing a support start request which is a signal including operation screen information for specifying the one or more operation items displayed on the operation screen; transmitting the support start request to the supporting apparatus; receiving guide graphical user interface (GUI) information from the supporting apparatus, the guide GUI information indicating an operation item to be operated by the supported user from among the one or more operation items; and superimposing a guide GUI on the operation screen, the guide GUI being an image for showing the supported user the operation item indicated by the guide GUI information.

A recording medium according to another aspect of the present invention is a recording medium having recorded thereon a program for causing a computer to operate as a supported apparatus in an inter-apparatus guide system in which a supported user who operates the supported apparatus is supported by a supporting user through a supporting apparatus that is connected to the supported apparatus via a network, the program causing the computer to execute: displaying an operation screen including one or more operation items, on the supported apparatus; issuing a support start request which is a signal including operation screen information for specifying the one or more operation items displayed on the operation screen; transmitting the support start request to the supporting apparatus; receiving guide graphical user interface (GUI) information from the supporting apparatus, the guide GUI information indicating an operation item to be operated by the supported user from among the one or more operation items; and superimposing a guide GUI on the operation screen, the guide GUI being an image for showing the supported user the operation item indicated by the guide GUI information.

An integrated circuit according to another aspect of the present invention is an integrated circuit included in a supported apparatus in an inter-apparatus guide system in which a supported user who operates the supported apparatus is supported by a supporting user through a supporting apparatus that is connected to the supported apparatus via a network, the supported apparatus including an output unit that displays an operation screen which is an image including one or more operation items, the integrated circuit including: a request issuance unit that issues a support start request which is a signal including operation screen information for specifying the one or more operation items displayed on the operation screen; a transmission and reception unit that transmits the support start request to the supporting apparatus, and receives guide graphical user interface (GUI) information from the supporting apparatus, the guide GUI information indicating an operation item to be operated by the supported user from among the one or more operation items; and a guide GUI superimposition unit that superimposes a guide GUI on the operation screen based on the guide GUI information, the guide GUI being an image for showing the supported user the operation item to be operated.

A supporting method according to another aspect of the present invention is a supporting method performed by a supporting apparatus in an inter-apparatus guide system in which a supported user who operates a supported apparatus is supported by a supporting user through the supporting apparatus that is connected to the supported apparatus via a network, the supporting method including: receiving operation screen information for specifying one or more operation items displayed on an operation screen in the supported apparatus, from the supporting apparatus; generating a guide screen based on the operation screen information, the guide screen being an operation screen corresponding to the operation screen in the supported apparatus; displaying the guide screen; obtaining an operation performed by the supporting user on the guide screen; generating guide graphical user interface (GUI) information for specifying an operation item operated by the supporting user on the guide screen; and transmitting the guide GUI information to the supported apparatus.

A recording medium according to another aspect of the present invention is a recording medium having recorded thereon a program for causing a computer to operate as a supporting apparatus in an inter-apparatus guide system in which a supported user who operates a supported apparatus is supported by a supporting user through the supporting apparatus that is connected to the supported apparatus via a network, the program causing the computer to execute: receiving operation screen information for specifying one or more operation items displayed on an operation screen in the supported apparatus, from the supporting apparatus; generating a guide screen based on the operation screen information, the guide screen being an operation screen corresponding to the operation screen in the supported apparatus; displaying the guide screen; obtaining an operation performed by the supporting user on the guide screen; generating guide graphical user interface (GUI) information for specifying an operation item operated by the supporting user on the guide screen; and transmitting the guide GUI information to the supported apparatus.

An integrated circuit according to another aspect of the present invention is an integrated circuit included in a supporting apparatus in an inter-apparatus guide system in which a supported user who operates a supported apparatus is supported by a supporting user through the supporting apparatus that is connected to the supported apparatus via a network, the supporting apparatus including: an output unit that displays a guide screen; and an input unit that obtains an operation performed by the supporting user on the guide screen, the integrated circuit including: a transmission and reception unit that receives operation screen information for specifying one or more operation items in the supported apparatus, from the supported apparatus; a guide screen generation unit that generates the guide screen based on the operation screen information, the guide screen being an image including the one or more operation items; and a guide GUI generation unit that generates guide graphical user interface (GUI) information indicating an operation item operated by the supporting user on the guide screen, wherein the transmission and reception unit transmits the guide GUI information to the supported apparatus.

These general and specific aspects may be implemented using a system, a method, an integrated circuit, a computer program, or a recording medium, or any combination of systems, methods, integrated circuits, computer programs, and recording media.

The following describes an embodiment of the present invention with reference to drawings. Note that the drawings are used for describing the technical features which can be employed by the present invention. The described apparatus structures and various process flowcharts are not intended to limit the scope of the present invention and are merely illustrative, unless otherwise stated.

An inter-apparatus guide system according to an aspect of the present invention is an inter-apparatus guide system in which a user unaccustomed to operate a home appliance using a supported apparatus is provided with opportunities to learn the operation while communicating with a user of a supporting apparatus. An inter-apparatus guide system in which a supported user who operates a supported apparatus is supported by a supporting user through a supporting apparatus that is connected to the supported apparatus via a network is assumed as an example.

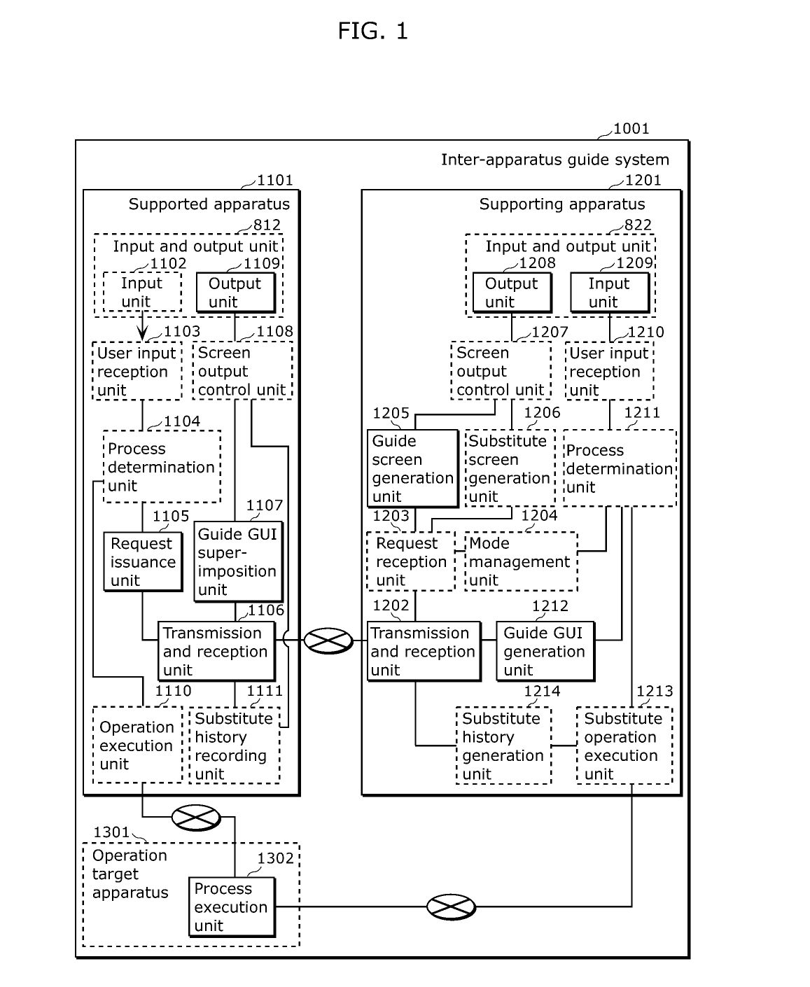

FIG. 1 is a functional block diagram showing an example of a structure of an inter-apparatus guide system 1001 in the embodiment of the present invention.

The inter-apparatus guide system 1001 includes a supported apparatus 1101, a supporting apparatus 1201, and an operation target apparatus 1301.

The supported apparatus 1101, the supporting apparatus 1201, and the operation target apparatus 1301 are connected to each other via a network such as a LAN (Local Area Network). Though the supported apparatus 1101 and the operation target apparatus 1301 are connected via a network in this embodiment, the supported apparatus 1101 may include the operation target apparatus 1301 as described later. In this case, the supported apparatus 1101 receives operation support for the operation of the supported apparatus 1101 itself, from the supporting apparatus 1201.

The supported apparatus 1101 and the supporting apparatus 1201 are each an apparatus, such as a smartphone, a tablet terminal, or a TV, that receives an operation from a user on a displayed operation screen. The operation screen mentioned here is an image including one or more operation items that are subjected to be operated by the user (e.g. finger touching). The operation target apparatus 1301 is an apparatus, such as a smartphone, a tablet terminal, a TV, or a recorder, that executes a process according to an operation from a user or an operation from another apparatus.

The supported apparatus 1101 is a supported apparatus in the inter-apparatus guide system 1001 in which the supported user who operates the supported apparatus 1101 is supported by the supporting user through the supporting apparatus 1201 that is connected to the supported apparatus 1101 via a network.

The supporting apparatus 1201 is a supporting apparatus in the inter-apparatus guide system 1001 in which the supported user who operates the supported apparatus 1101 is supported by the supporting user through the supporting apparatus 1201 that is connected to the supported apparatus 1101 via a network.

The following describes each structural element included in the supported apparatus 1101. In FIG. 1, functional blocks necessary in the supported apparatus 1101 are indicated by solid lines, and functional blocks that may be omitted are indicated by dashed lines.

The supported apparatus 1101 includes an input unit 1102, a user input reception unit 1103, a process determination unit 1104, a request issuance unit 1105, a transmission and reception unit 1106, a guide graphical user interface (GUI) superimposition unit 1107, a screen output control unit 1108, an output unit 1109, an operation execution unit 1110, and a substitute history recording unit 1111. In the supported apparatus 1101 in this embodiment, the input unit 1102 and the output unit 1109 are integrated as an input and output unit 812. For example, the input and output unit 812 is a touch display or the like. The supported apparatus 1101 in this embodiment displays an operation screen on the input and output unit 812, and obtains, as an input, a touch operation or the like by the user on the operation screen.

The input unit 1102 in the supported apparatus 1101 recognizes the input operation by the user, and outputs an electrical signal corresponding to the input operation to the user input reception unit 1103. The input unit 1102 is an input interface that converts the input operation by the user to an electrical signal processible by the supported apparatus 1101. The input unit 1102 may obtain not only an input operation with the user's finger(s) on a touch panel, a remote control, a keyboard, or the like but also an input operation with voice through a microphone or the like, and convert it to an electrical signal.

The user input reception unit 1103 in the supported apparatus 1101 obtains the electrical signal corresponding to the input operation by the user from the input unit 1102, and notifies the process determination unit 1104 of the user input.

The process determination unit 1104 in the supported apparatus 1101, when notified of the user input, specifies whether the input is a support request or an operation request. The support request is a user input indicating that the user as the supported user requests the supporting user to teach how to operate the supported apparatus 1101 through the supporting apparatus 1201. The operation request is a user input indicating that the user requests the operation execution unit in the supported apparatus 1101 to execute a process.

When receiving the support request from the supported user, the process determination unit 1104 determines the type of the mode of operation support designated by the supported user. In the case where the type of the mode is determined as a guide mode (hereafter also referred to as “first mode”) and the transmission and reception unit 1106 receives guide GUI information from the supporting apparatus 1201, the process determination unit 1104 causes the guide GUI superimposition unit 1107 to superimpose a guide GUI on the operation screen. The guide GUI information is information indicating an operation item to be operated by the supported user from among the operation items included in the operation screen. The guide GUI is an image for showing the supported user the operation item to be operated. The guide GUI information and the guide GUI will be described in more detail later.

In detail, in the case where the user input is the support request, the process determination unit 1104 specifies the support mode designated by the user and the supporting apparatus used by the supporting user. The process determination unit 1104 then passes the mode and an ID which is an identifier for specifying the supporting apparatus to the request issuance unit 1105, and makes a support request. Two mode types, e.g. a guide mode and a substitute operation mode, are assumed as described later.

In the case where the user input is the operation request, on the other hand, the process determination unit 1104 passes the information of the operation to the operation execution unit 1110, and requests the operation execution unit 1110 to execute the operation. For example, in the case of the operation request in the guide mode, when the user performs an input operation on the operation screen on which the guide GUI is superimposed, the process determination unit 1104 passes the information of the input operation performed by the user to the operation execution unit 1110 and requests the operation execution unit 1110 to execute the corresponding operation, and also notifies the request issuance unit 1105 of the update of the operation screen, as described later.

Here, whether the user input is the support request or the operation request, whether the mode is the guide mode or the substitute operation mode in the case where the user input is the support request, and which apparatus is the supporting apparatus can be determined, for example, by preprogramming the correspondence between user input operations (e.g. finger touching) on the operation components arranged on the operation screen in the supported apparatus 1101 and processes to be executed.

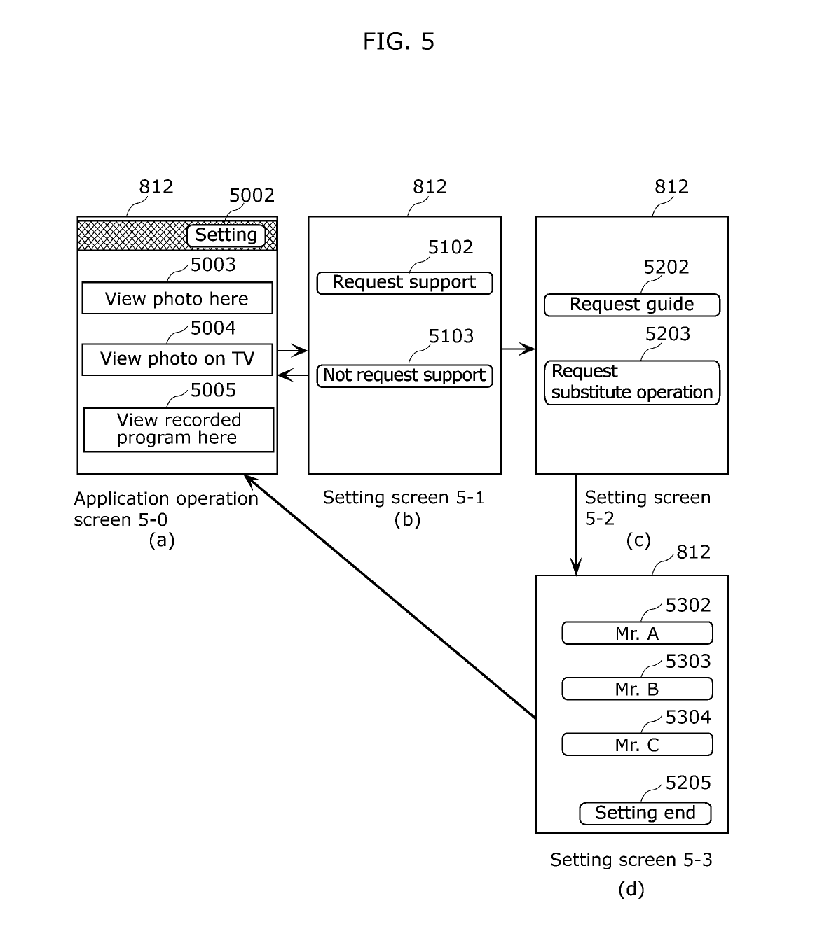

FIG. 5 is a diagram showing an example of transition of the operation screen displayed on the input and output unit 812 in the supported apparatus.

When the user touches a “setting” button 5002 on an application operation screen shown in (a) in FIG. 5, the screen transitions to a setting screen 5-1 shown in (b) in FIG. 5. When the user touches a “request support” button 5102 on the setting screen 5-1, the process determination unit 1104 determines that the user input is the support request, and the screen transitions to a setting screen 5-2 shown in (c) in FIG. 5. When the user touches a “request guide” button 5202 on the setting screen 5-2, the process determination unit 1104 determines that the support mode is the guide mode. When the user touches a “request substitute operation” button 5203 on the setting screen 5-2, on the other hand, the process determination unit 1104 determines that the support mode is the substitute operation mode.

Whichever mode is selected, the screen transitions to a setting screen 5-3 shown in (d) in FIG. 5. In the setting screen 5-3, buttons 5302 to 5304 showing names of supporting user candidates associated with supporting apparatuses beforehand are displayed on the operation screen. The supporting apparatus is determined from the name of the supporting user touched by the user. When the user touches a “setting end” button 5305, the process determination unit 1104 passes the determined information to the request issuance unit 1105 and makes the support request, and then returns to the application operation screen shown in (a) in FIG. 5.

In the case where the user selects a button other than the “setting” button 5002 provided for support setting on the application operation screen shown in (a) in FIG. 5, the process determination unit 1104 determines that the user input is the operation request. In detail, when the user touches a button 5003, 5004, or 5005, the process determination unit 1104 determines that the user input is the operation request. The process determination unit 1104 accordingly passes the information of the operation to the operation execution unit 1110, and requests the operation execution unit 1110 to execute the operation.

Referring back to FIG. 1, the request issuance unit 1105 issues a support start request which is a signal including: operation screen information for specifying the operation items displayed on the operation screen; and information indicating the type of the mode determined by the process determination unit 1104.

In more detail, the process determination unit 1104 determines the mode, upon receiving the support request from the user. In the case where the mode is determined as the guide mode, the request issuance unit 1105 passes the current operation screen information, the mode, and the ID of the supporting apparatus to the transmission and reception unit 1106, and makes the support start request in the guide mode to the supporting apparatus 1201. After this, the request issuance unit 1105 sets the process determination unit 1104 so that the supported apparatus 1101 does not receive an operation request from the user until the guide GUI superimposition unit 1107 superimposes the guide GUI on the current operation screen based on the information from the supporting apparatus 1201 as described later or until the user cancels the support start request in the guide mode.

In the case where the mode is determined as the substitute operation mode, on the other hand, the request issuance unit 1105 passes the current operation screen information, the mode, the ID of the supporting apparatus, and an ID which is an identifier for specifying the operation target apparatus 1301 to the transmission and reception unit 1106, and makes the support start request in the substitute operation mode to the supporting apparatus 1201. After this, the request issuance unit 1105 sets the process determination unit 1104 so that the supported apparatus 1101 does not receive an operation request from the user until the support start request in the substitute operation mode is canceled.

The operation screen information mentioned here is information for generating a guide screen by a guide screen generation unit 1205 in the supporting apparatus 1201, or information for generating a substitute operation screen by a substitute screen generation unit 1206 in the supporting apparatus 1201.

The guide screen and the substitute operation screen are each an image that is displayed on the supporting apparatus 1201 and includes the operation items displayed on the operation screen in the supported apparatus 1101.

In detail, the operation screen information includes, for example, the identifiers for specifying the operation components arranged on the operation screen, event information indicating processes when the components are operated by the user, the size, shape, and position information of each component, the number of components, and the like.

Here, a URL that enables the operation screen to be uniquely specified between the supporting apparatus 1201 and the supported apparatus 1101 may be passed from the supported apparatus 1101 to the supporting apparatus 1201 as the operation screen information so that the supporting apparatus generates the operation screen with reference to the URL.

Here, the supporting apparatus does not need to arrange the operation components on the guide screen or the substitute operation screen in the same sizes, shapes, or positions as those on the operation screen. The present invention is applicable even when the layout of the guide screen is customized according to the screen resolution, input device, or user of the supporting apparatus.

In more detail, supposing that the operation components are buttons as an example, the supported apparatus 1101 and the supporting apparatus 1201 only need to share the same number of buttons with the same labels in the guide mode. That is, the operation screen information only needs to include the number of buttons as the operation components displayed on the operation screen in the supported apparatus 1101 and the label assigned to each button. In which positions and shapes the buttons are displayed on the guide screen by the supporting apparatus 1201 based on the operation component information depends on the implementation of the supporting apparatus 1201. Likewise, in the substitute operation mode, the supported apparatus 1101 and the supporting apparatus 1201 only need to share the same number of buttons with the same labels, and also share information of an event handler indicating a process associated with the operation of each button. In the substitute operation mode, the supporting apparatus 1201 itself operates the operation target apparatus 1301, as described later. Therefore, the substitute operation screen needs to be not a mere imitation but a screen that enables the same operations as the operation screen in the supported apparatus 1101 to be performed on the operation target apparatus 1301.

As mentioned above, the operation screen information is information for logically associating the operation items in the supported apparatus 1101 and the operation items in the supporting apparatus 1201 so that the operation items are shared between the two apparatuses, regardless of any difference in specifications (e.g. the resolution, the number of displayable colors, the device size) between the display device in the supported apparatus 1101 and the display device in the supporting apparatus 1201.

In the case where the process determination unit 1104 notifies the request issuance unit 1105 of the update of the operation screen, the request issuance unit 1105 passes the updated operation screen information to the transmission and reception unit 1106, and requests the supporting apparatus 1201 to continue the support in the same mode. After this, the request issuance unit 1105 again sets the process determination unit 1104 so as not to receive an operation request from the user until the guide GUI is superimposed on the operation screen or until the support request in the guide mode is canceled.

The transmission and reception unit 1106 in the supported apparatus 1101 is a communication interface that transmits the support start request to the supporting apparatus 1201 and receives the guide GUI information from the supporting apparatus 1201. The communication medium used here may be wired or wireless. Examples of the communication medium include a wired or wireless LAN, infrared communication, and short-range wireless communication.

In more detail, when instructed by the request issuance unit 1105, in the guide mode the transmission and reception unit 1106 transmits the support start request including the guide mode as the mode, the operation screen information, and the ID as the identifier for specifying the supported apparatus 1101 to the supporting apparatus 1201. In the substitute operation mode, on the other hand, the transmission and reception unit 1106 transmits the support start request including the substitute operation mode as the mode, the operation screen information, the ID of the supported apparatus 1101, and the ID of the operation target apparatus 1301 to the supporting apparatus 1201.

Here, a support ID is defined as information for associating the support start request from the supported apparatus 1101 to the supporting apparatus 1201 with the response from the supporting apparatus 1201 to the supported apparatus 1101 in reply to the support start request. The support ID is an ID issued by the supporting apparatus 1201 or the supported apparatus 1101 when the supported apparatus 1101 makes the support start request to the supporting apparatus 1201, and has a unique value between the connected terminals. The support ID may be issued by any of the supported apparatus and the supporting apparatus, so long as its value is unique between the connected terminals.

In the case of updating the operation screen in the guide mode, the transmission and reception unit 1106 in the supported apparatus 1101 transmits the support ID, the mode, the latest operation screen information, and the ID of the supported apparatus 1101 to the supporting apparatus 1201, and makes a support continuation request.

Moreover, upon receiving the guide GUI information of the guide GUI and the support ID in the guide mode from the supporting apparatus 1201, the transmission and reception unit 1106 in the supported apparatus 1101 provides the mode, the guide GUI information, and the support ID obtained from the supporting apparatus 1201, to the guide GUI superimposition unit 1107. Upon receiving substitute operation history information of a substitute operation history and the support ID in the substitute operation mode from the supporting apparatus 1201, the transmission and reception unit 1106 provides the mode, the substitute operation history information, and the support ID obtained from the supporting apparatus 1201, to the substitute history recording unit 1111. This will be described in more detail later.

The guide GUI superimposition unit 1107, in the case of obtaining the guide GUI information indicating the operation item to be operated by the supported user from among the operation items displayed on the operation screen in the supported apparatus 1101, superimposes the guide GUI which is an image for showing the supported user the operation item to be operated, on the operation screen.

In more detail, upon receiving the guide GUI information from the transmission and reception unit 1106, the guide GUI superimposition unit 1107 requests the screen output control unit 1108 to perform output so that the operation screen on which the guide GUI is superimposed is displayed on the input and output unit 812. The guide GUI and the guide GUI information will be described in more detail later with regard to a structure of a guide GUI generation unit 1212 in the supporting apparatus 1201.

The guide GUI superimposition unit 1107 does not need to display the guide GUI on the operation screen in the same size, shape, or position as the guide GUI generated by the supporting apparatus 1201 and operated by the supporting user. For instance, in the case where there is a difference in screen resolution, operation component arrangement, or the like between the supported apparatus and the supporting apparatus, the size, shape, or position of the guide GUI may be adjusted according to the resolution of the input and output unit 812 in the supported apparatus 1101, the arrangement of the operation components on the operation screen, and the like so that the user can recognize the correspondence between the guide GUI and the operation item, i.e. which operation item is shown by the guide GUI to be operated.

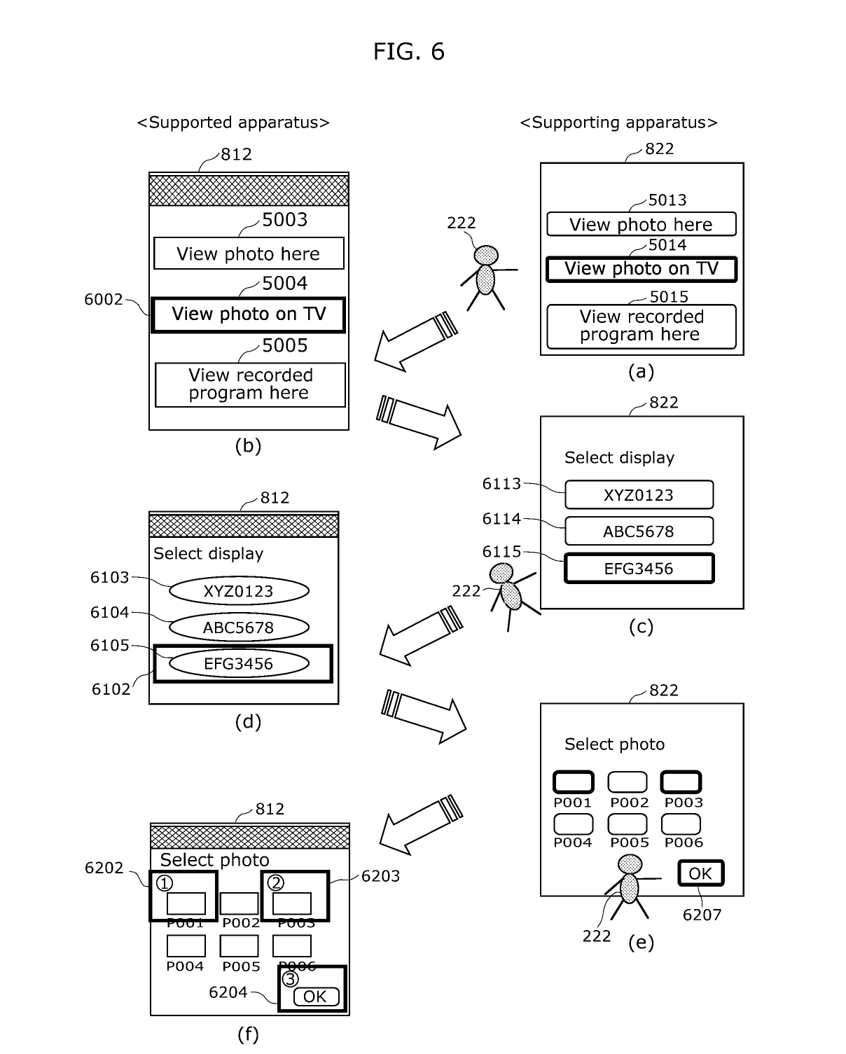

FIG. 6 is a diagram showing an example of a screen in which the guide GUI superimposition unit 1107 superimposes the guide GUI on the operation screen displayed on the input and output unit 812. In particular, FIG. 6 shows interaction between the operation of the operation screen in the supporting apparatus 1201 by the supporting user and the operation of the operation screen in the supported apparatus 1101 by the supported user.

For purposes of illustration, it is assumed here that a supporting user 222 is requested by a supported user to provide support in the guide mode for an operation method of viewing photos on a TV.

First, the supporting user 222 operates an operation screen (guide screen) displayed on an input and output unit 822 which is a touch display in the supporting apparatus 1201, and touches a button 5014 (“view photo on TV”) ((a) in FIG. 6). As a result, information indicating the operation item on the operation screen in the supported apparatus 1101 corresponding to the button 5014 is transmitted from the supporting apparatus 1201 to the supported apparatus 1101 as guide GUI information.

Having received the guide GUI information, the guide GUI superimposition unit 1107 superimposes a guide GUI 6002 (e.g. a thick line frame) on the button 5004 (“view photo on TV”) corresponding to the operation item indicated by the guide GUI information ((b) in FIG. 6).

The supported user recognizes the guide GUI 6002 superimposed on the “view photo on TV” button 5004 on the operation screen shown in (b) in FIG. 6, and touches the “view photo on TV” button 5004 on the operation screen. The process determination unit 1104 responsively passes the information of the operation that the button 5004 is touched to the operation execution unit 1110, and requests the operation execution unit 1110 to execute the process corresponding to the operation. As a result, the operation screen displayed on the input and output unit 812 is updated with an operation screen (e.g. a screen in (d) in FIG. 6 without a guide GUI 6102) for selecting a TV to display photos. The process determination unit 1104 then instructs the request issuance unit 1105 to issue an operation screen update notification including operation screen information corresponding to the updated operation screen. The issued operation screen update notification is transmitted to the supporting apparatus 1201.

The supporting apparatus 1201 displays a new guide screen corresponding to the received operation screen information, on the input and output unit 822 ((c) in FIG. 6).

For example, the supporting user 222 touches a button 6115 corresponding to an identifier “EFG3456” of a TV informed beforehand as the TV used by the supported user to view photos, on the guide screen displayed on the input and output unit 822. As a result, information indicating the operation item on the operation screen in the supported apparatus 1101 corresponding to the button 6115 is transmitted from the supporting apparatus 1201 to the supported apparatus 1101 as guide GUI information.

Having received the guide GUI information, the guide GUI superimposition unit 1107 superimposes the guide GUI 6102 (e.g. a thick line frame) on a button 6105 (“EFG3456”) which is the operation item indicated by the guide GUI information and corresponds to the button 6115 ((d) in FIG. 6).

When the supported user touches the button 6105 on which the guide GUI 6102 is superimposed, the process determination unit 1104 passes the information of the operation that the button 6105 is touched to the operation execution unit 1110, and requests the operation execution unit 1110 to execute the operation. As a result, the operation screen displayed on the input and output unit 812 is updated with an operation screen (e.g. a screen in (f) in FIG. 6 without guide GUIs 6202 to 6204) for selecting photos to be displayed on the TV. The process determination unit 1104 then instructs the request issuance unit 1105 to issue an operation screen update notification including operation screen information corresponding to the updated operation screen. The issued operation screen update notification is transmitted to the supporting apparatus 1201.

The supporting apparatus 1201 displays a new guide screen corresponding to the received operation screen information, on the input and output unit 822 ((e) in FIG. 6).

For example, the supporting user 222 touches buttons P001 and P003 corresponding to photos informed beforehand as photos which the supported user wants to view on the TV, on the guide screen displayed on the input and output unit 822. Two photos are thus selected. The supporting user 222 further touches an “OK” button to indicate the completion of the photo selection. As a result, information indicating the operation items on the operation screen in the supported apparatus 1101 corresponding to the buttons P001 and P003 and the “OK” button 6207 is transmitted from the supporting apparatus 1201 to the supported apparatus 1101 as guide GUI information.

Having received the guide GUI information, the guide GUI superimposition unit 1107 superimposes the guide GUIs 6202 to 6204 respectively on the buttons which are the operation items indicated by the guide GUI information and correspond to the buttons P001 and P003 and the “OK” button 6207 ((f) in FIG. 6).

Each of the guide GUIs 6202 to 6204 is accompanied with an image indicating information of the sequence in which the supporting user of the supporting apparatus 1201 operates the operation items. That is, the guide GUIs and the images indicating the operation sequence are superimposed on the operation screen so that the supporting user of the supported apparatus 1101 can recognize the operation sequence of the operation items.

Referring back to FIG. 1, the screen output control unit 1108, when instructed by the guide GUI superimposition unit 1107, updates the drawing of the operation screen and outputs the drawing information to the output unit 1109.

The output unit 1109 is a display device that displays the operation screen including the operation items in the supported apparatus 1101. In detail, the output unit 1109 outputs the screen expressed by the drawing information generated by the screen output control unit 1108. That is, the output unit 1109 outputs the operation screen received from the screen output control unit 1108, to the user. For example, a liquid crystal display, a CRT (Cathode Ray Tube), or the like is available as the output unit 1109.

The operation execution unit 1110, when receiving the operation instruction from the process determination unit 1104, transmits an operation signal for operating the external operation target apparatus 1301 to the operation target apparatus 1301, to instruct the operation target apparatus 1301 to execute the process.

For example, consider a situation where the supported user uses the supported apparatus 1101 as an operation remote control of the operation target apparatus 1301 in the guide mode. When the supported user performs an operation on the operation screen on which the guide GUI is superimposed, the operation execution unit 1110 receives the operation instruction including information for specifying the operation performed by the supported user from the process determination unit 1104, and instructs the operation target apparatus 1301 to execute the process corresponding to the operation performed by the supported user.

In more detail, the process determination unit 1104: causes the operation execution unit 1110 to transmit, to the operation target apparatus 1301, an operation signal corresponding to the operation performed by the supported user on the operation screen; updates the operation screen to conform to the result of the process executed by the operation target apparatus 1301 according to the operation signal; and causes the transmission and reception unit 1106 to transmit, to the supporting apparatus 1201, the operation screen information indicating the operation items included in the updated operation screen.

The substitute history recording unit 1111 records substitute operation history information which is history information of the operation performed by the supporting user 222 on the operation item(s) displayed on the supporting apparatus 1201.

In detail, in the case where the process determination unit 1104 determines that the type of the mode is the substitute operation mode, the process determination unit 1104 causes the substitute history recording unit 1111 to record the substitute operation history information obtained from the supporting apparatus 1201 and the operation screen in association with each other.

In more detail, when receiving the substitute operation history information from the transmission and reception unit 1106, the substitute history recording unit 1111 records the substitute operation history information in association with the support ID and the operation screen information. The recorded substitute operation history information is displayed on the input and output unit 812 in association with the operation screen, for example when requested by the supported user of the supported apparatus 1101. The supported user can learn the operation method of the operation execution unit 1110, from the displayed substitute operation history information.

This completes the description of each structural element included in the supported apparatus 1101.

The following describes each structural element included in the supporting apparatus 1201. In FIG. 1, functional blocks necessary in the supporting apparatus 1201 are indicated by solid lines, and functional blocks that may be omitted are indicated by dashed lines.

The supporting apparatus 1201 includes a transmission and reception unit 1202, a request reception unit 1203, a mode management unit 1204, the guide screen generation unit 1205, the substitute screen generation unit 1206, a screen output control unit 1207, an output unit 1208, an input unit 1209, a user input reception unit 1210, a process determination unit 1211, the guide GUI generation unit 1212, a substitute operation execution unit 1213, and a substitute history generation unit 1214. In the supporting apparatus 1201 in this embodiment, the input unit 1209 and the output unit 1208 are integrated as the input and output unit 822. For example, the input and output unit 822 is a touch display or the like. The supporting apparatus 1201 in this embodiment displays an operation screen (substitute operation screen) on the input and output unit 822, and obtains, as an input, a touch operation or the like by the user on the operation screen.

The transmission and reception unit 1202 in the supporting apparatus 1201 is a communication interface that receives, from the supported apparatus 1101, the operation screen information for specifying the operation items displayed on the operation screen in the supported apparatus 1101, and transmits the guide GUI information to the supported apparatus 1101. The communication medium used here may be wired or wireless, as with the transmission and reception unit 1106. Examples of the communication medium include a wired or wireless LAN, infrared communication, and short-range wireless communication.

In more detail, when receiving the support start request from the supported apparatus 1101, the transmission and reception unit 1202 in the supporting apparatus 1201 passes the support ID, the mode, the operation screen information, and the ID of the supported apparatus 1101, to the request reception unit 1203.

Moreover, when receiving the support continuation request including the support ID of the support being executed and the updated operation screen information from the supported apparatus 1101, the transmission and reception unit 1202 in the supporting apparatus 1201 passes the support ID, the mode, the updated operation screen information, and the ID of the supported apparatus 1101, to the request reception unit 1203.

The request reception unit 1203 determines the type of the mode based on the information included in the support start request. In the case of determining the type of the mode as the guide mode, the request reception unit 1203 causes the below-mentioned guide screen generation unit 1205 to generate the guide screen. In the case of determining the type of the mode as the substitute operation mode, the request reception unit 1203 causes the below-mentioned substitute screen generation unit 1206 to generate the substitute screen.

In more detail, the request reception unit 1203 sets the support ID, the mode, the operation screen information, and the ID of the supported apparatus 1101, in the mode management unit 1204. In the case of determining the mode as the guide mode, the request reception unit 1203 passes the operation screen information to the guide screen generation unit 1205, and requests the guide screen generation unit 1205 to generate the guide screen. In the case of determining the mode as the substitute operation mode, the request reception unit 1203 passes the operation screen information to the substitute screen generation unit 1206, and requests the substitute screen generation unit 1206 to generate the substitute operation screen.

The mode management unit 1204 holds the support ID, the mode, and the ID of the supported device 1101 set by the request reception unit 1203.

The guide screen generation unit 1205 generates the guide screen which is an image including one or more operation items, based on the operation screen information obtained from the supported apparatus 1101. That is, the guide screen at least includes images representing operation components each of which corresponds to a different one of all operation items included in the operation screen information.

In detail, when instructed to generate the guide screen by the request reception unit 1203, the guide screen generation unit 1205 generates the guide screen using the operation screen information received from the supported apparatus 1101. The guide screen generation unit 1205 then requests the screen output control unit 1207 to output the screen.

The operation screen information mentioned here has already been described with regard to the structure of the request issuance unit 1105 in the supported apparatus 1101.

Here, the guide screen generation unit 1205 may generate the guide screen whose layout is customized according to the screen resolution, input device, or user of the supporting apparatus 1201.

The substitute screen generation unit 1206 generates the substitute screen which is an image corresponding to the operation screen in the supported apparatus 1101, based on the operation screen information obtained from the supported apparatus 1101. That is, the substitute screen at least includes images representing operation components each of which corresponds to a different one of all operation items included in the operation screen information.

In detail, when instructed to generate the substitute operation screen by the request reception unit 1203, the substitute screen generation unit 1206 generates the substitute operation screen using the operation screen information received from the supported apparatus 1101. The substitute screen generation unit 1206 then requests the screen output control unit 1207 to output the screen.

Here, the substitute screen generation unit 1206 may generate the substitute screen whose layout is customized according to the screen resolution, input device, or user of the supporting apparatus 1201, as with the guide screen.

The screen output control unit 1207 causes the output unit 1208 to display the requested screen out of the guide screen and the substitute screen.

The output unit 1208 in the supporting apparatus 1201 displays the guide screen or the substitute screen received from the screen output control unit 1207.

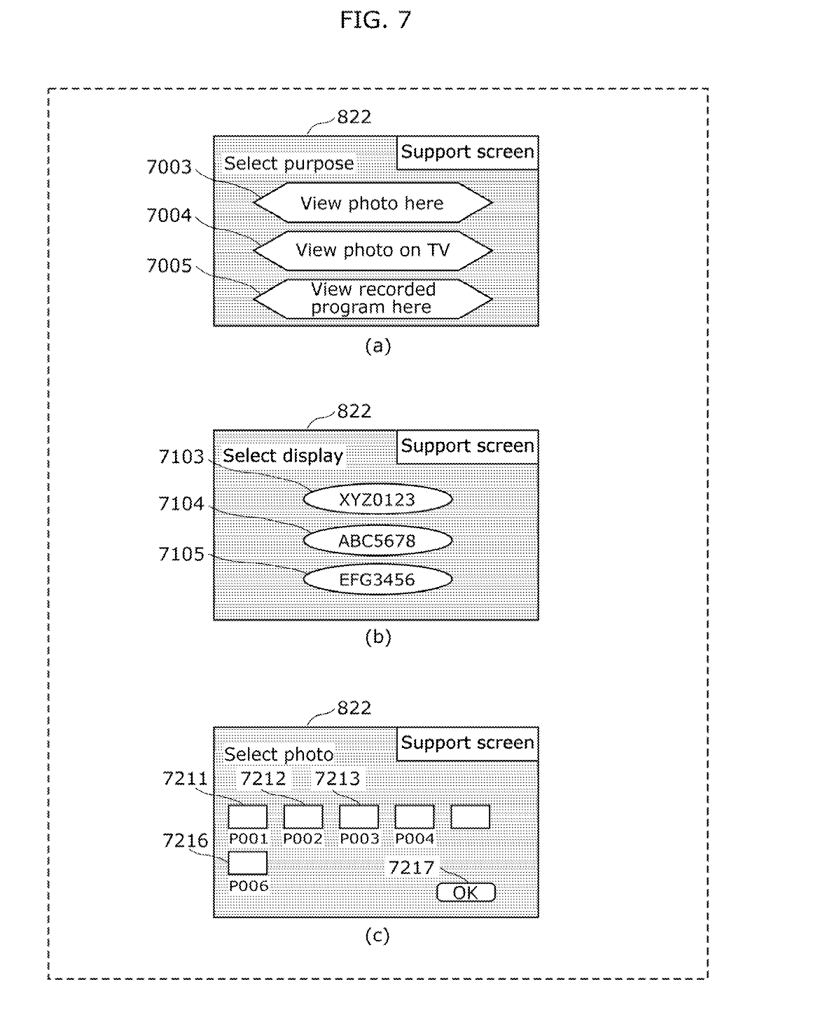

FIG. 7 is a diagram showing an example of the guide screen generated by the guide screen generation unit 1205 and displayed on the input and output unit 822.

(a) in FIG. 7 shows an example of the guide screen corresponding to the operation screen in the supported apparatus 1101 shown in (b) in FIG. 6. Though (a) in FIG. 6 also shows an example of the guide screen corresponding to the operation screen in the supported apparatus 1101, the button shape and the like are different between the guide screen in (a) in FIG. 7 and the guide screen in (a) in FIG. 6. This is to illustrate that the generated guide screen depends on the supporting apparatus which differs in type.

The operation items arranged on the guide screen and the operation items arranged on the operation screen are associated one-to-one with each other. In detail, a “view photo here” button 7003 on the guide screen in (a) in FIG. 7 corresponds to the “view photo here” button 5003 on the operation screen in (b) in FIG. 6. Likewise, a “view photo on TV” button 7004 on the guide screen in (a) in FIG. 7 corresponds to the “view photo on TV” button 5004 on the operation screen in (b) in FIG. 6. A “view recorded program here” button 7005 on the guide screen in (a) in FIG. 7 corresponds to the “view recorded program here” button 5005 on the operation screen in (b) in FIG. 6.

The correspondence between the operation items on the guide screen and the operation items on the operation screen can be established, for example, by presetting an operation item ID (e.g. a number or a symbol) which is an identifier common to the corresponding operation items. In more detail, the supporting apparatus 1201 can notify the supported apparatus 1101 of the operation item operated by the supporting user, through the use of the identifier for identifying each operation item included in the operation screen information obtained from the supported apparatus 1101. Note that information other than the above-mentioned identifier may be used to establish the correspondence between the operation items, so long as the information enables the supported apparatus 1101 and the supporting apparatus 1201 to uniquely identify the correspondence between operation items.

In other words, the supported apparatus 1101 displays a first image corresponding to the operation item ID on the operation screen, from among a plurality of images (icons representing operation items) held beforehand. Likewise, the supporting apparatus 1201 displays a second image corresponding to the operation item ID on the guide screen, from among a plurality of images (icons representing operation items) held beforehand.

The first image and the second image may be the same image, or different in shape, size, resolution, or the like. Thus, the operation screen and the guide screen can be displayed regardless of the devices in the supported apparatus 1101 and the supporting apparatus 1201.

For example, when the supporting user of the supporting apparatus 1201 touches the “view photo on TV” button 7004 which is an operation item on the guide screen, the below-mentioned guide GUI generation unit 1212 generates a guide GUI in association with the touched operation item. Guide GUI information including information (e.g. the above-mentioned identifier) for specifying which operation item is indicated by the generated guide GUI to be operated is transmitted to the supported apparatus 1101, and the guide GUI is superimposed by the guide GUI superimposition unit 1107 on the “view photo on TV” button which is an operation item on the operation screen. The operation screen in (b) in FIG. 6 described above is an example of the screen in which the guide GUI 6002 is superimposed on the “view photo on TV” button 5004 which is an operation item on the operation screen.

(b) in FIG. 7 shows an example of the guide screen generated by the supporting apparatus 1201 upon receiving the operation screen update notification that is transmitted from the supported apparatus 1101 when the supported user of the supported apparatus 1101 touches the “view photo on TV” button 5004 on the operation screen shown in (b) in FIG. 6. Though (c) in FIG. 6 also shows an example of the guide screen generated by the supporting apparatus upon receiving the operation screen update notification, the button shape and the like are different between the guide screen in (b) in FIG. 7 and the guide screen in (c) in FIG. 6. This is to illustrate that the generated guide screen depends on the supporting apparatus which differs in type.

For example, when the supporting user of the supporting apparatus 1201 touches an “EFG3456” button 7105 which is an operation item on the guide screen, the below-mentioned guide GUI generation unit 1212 generates a guide GUI in association with the touched operation item.

Guide GUI information including information for specifying which operation item is indicated by the generated guide GUI to be operated is transmitted to the supported apparatus 1101, and the guide GUI is superimposed by the guide GUI superimposition unit 1107 on the “EFG3456” button on the operation screen.

The guide screen in (d) in FIG. 6 is an example of the screen in which the guide GUI 6102 is superimposed on the “EFG3456” button 6105.

Following this, when the supporting user of the supporting apparatus 1201 sequentially touches a photo selection button 7211, a photo selection button 7213, and an “OK” button 7217 which are operation items on a guide screen shown in (c) in FIG. 7, the below-mentioned guide GUI generation unit 1212 generates three guide GUIs in association with the touched operation items.

Guide GUI information for specifying the generated three guide GUIs, together with sequence information of the three guide GUIs in the order of operation by the user, is simultaneously transmitted to the supported apparatus 1101. The guide GUI superimposition unit 1107 superimposes the guide GUIs 6202 to 6204 on the corresponding buttons from among the buttons on the operation screen shown in (f) in FIG. 6, based on the obtained guide GUI information.

Referring back to FIG. 1, the input unit 1209 in the supporting apparatus 1201 obtains an operation on the guide screen by the supporting user. In detail, the input unit 1209 recognizes an input from the user, and provides the input to the user input reception unit 1210. The input unit 1209 is an input interface that converts the input from the user to an electrical signal processible by the supporting apparatus 1201.

The input unit 1209 may convert not only an input operation with the supporting user's finger(s) on a touch panel, a remote control, a keyboard, or the like but also an input operation with voice through a microphone or the like, to an electrical signal.

The user input reception unit 1210 in the supporting apparatus 1201 receives the user input from the input unit 1209, and notifies the process determination unit 1211 of the user input.

The process determination unit 1211 in the supporting apparatus 1201, when notified of the user input, checks the mode set in the mode management unit 1204. In the case where the set mode is the guide mode, the process determination unit 1211 requests the guide GUI generation unit 1212 to generate the guide GUI. That is, in the case where the type of the mode is determined as the guide mode, the process determination unit 1211 causes the guide GUI generation unit 1212 to generate the guide GUI information.

In the case where the mode set in the mode management unit 1204 is the substitute operation mode, the process determination unit 1211 passes the ID of the operation target apparatus 1301 to the below-mentioned substitute operation execution unit 1213, and requests the substitute operation execution unit 1213 to execute the process. That is, in the case where the type of the mode is determined as the substitute operation mode, the process determination unit 1211 causes the substitute operation execution unit 1213 to transmit an operation signal corresponding to the operation performed by the supporting user on the substitute screen, to the operation target apparatus 1301.

The guide GUI generation unit 1212 generates the guide GUI information indicating the operation item operated by the supporting user on the guide screen. When the guide GUI information is transmitted to the supported apparatus 1101, the supported apparatus 1101 uses this information as information indicating the operation item to be operated by the supported user from among the operation items displayed on the operation screen, and superimposes the corresponding guide GUI on the operation screen, as mentioned above.

In more detail, when instructed by the process determination unit 1211, the guide GUI generation unit 1212 generates the guide GUI information, passes the guide mode as the mode, the guide GUI information, and the support ID to the transmission and reception unit 1202, and requests the transmission and reception unit 1202 to transmit a signal including the passed information to the supported apparatus 1101.

Here, the guide GUI generation unit 1212 determines the size, shape, color, and position of the guide GUI, upon obtaining the input operation (e.g. touch operation) performed by the supporting user on the operation item on the guide screen in the supporting apparatus 1201. The guide GUI generation unit 1212 associates the guide GUI of the determined size and the like with the operation item on which the input operation is performed, thereby generating the guide GUI information.

Note that the supporting apparatus 1201 may display the guide GUI on the guide screen displayed on the input and output unit 822. In this case, the guide GUI is drawn, for example, by adding an image representation such as framing, coloring, or encircling to the operation item on the guide screen when the operation item is touched by the user.

As mentioned earlier, the guide GUI information is information for superimposing the guide GUI on the operation screen by the guide GUI superimposition unit 1107 in the supported apparatus 1101. The guide GUI information includes, for instance, the size, shape, color, and position information of the GUI to be placed on the screen.

The supported apparatus 1101 does not need to display the guide GUI on the operation screen in the same size, shape, or position as the guide GUI generated by the supporting apparatus 1201. For instance, in the case where there is a difference in screen resolution, operation component arrangement, or the like between the supported apparatus 1101 and the supporting apparatus 1201, the guide GUI superimposition unit 1107 may adjust the size, shape, or position of the guide GUI according to the screen and operation component arrangement in the supported apparatus 1101 so that the user can recognize the correspondence between the guide GUI and the operation item.

The substitute operation execution unit 1213, in the case where the type of the mode is determined as the substitute operation mode, causes the substitute history generation unit 1214 to generate the substitute operation history information which is the history information of the operation performed by the supporting user on the substitute screen. The substitute operation execution unit 1213 also causes the transmission and reception unit 1202 to transmit the substitute operation history information to the supported apparatus 1101. The substitute operation execution unit 1213 further transmits the operation signal which is a signal for operating the external operation target apparatus 1301, to the operation target apparatus 1301.

In more detail, when instructed by the process determination unit 1211, the substitute operation execution unit 1213 instructs the operation target apparatus 1301 to execute the process instructed by the process determination unit 1211. The substitute operation execution unit 1213 then instructs the substitute history generation unit 1214 to generate the substitute operation history information.

The substitute history generation unit 1214 generates the substitute operation history information which is the history information of the operation performed by the supporting user on the substitute screen.

In more detail, when instructed by the substitute operation execution unit 1213, the substitute history generation unit 1214 generates the substitute operation history information, passes the substitute operation mode as the mode, the substitute operation history information, and the support ID to the transmission and reception unit 1202, and requests the transmission and reception unit 1202 to transmit these information to the supported apparatus 1101.

This completes the description of the supporting apparatus 1201 in the embodiment of the present invention.

The following describes each structural element included in the inter-apparatus guide system 1001 in the embodiment of the present invention.

The operation target apparatus 1301 includes a process execution unit 1302.

The process execution unit 1302 executes the process according to the request from the operation execution unit 1110 in the supported apparatus 1101 or the substitute operation execution unit 1213 in the supporting apparatus 1201.

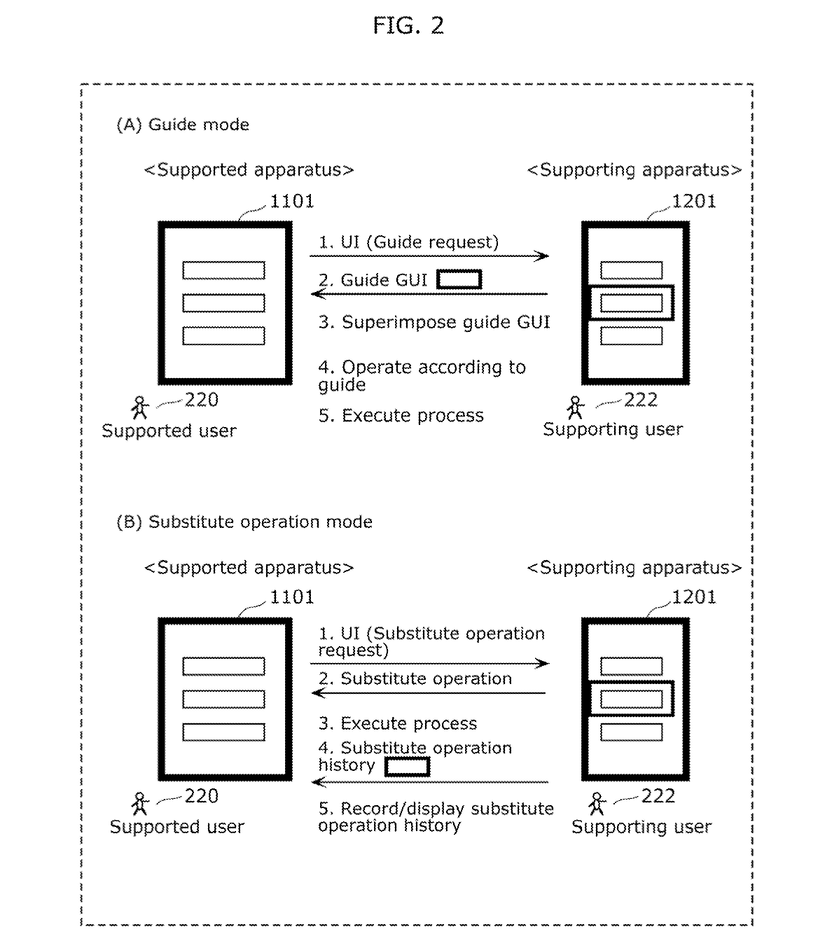

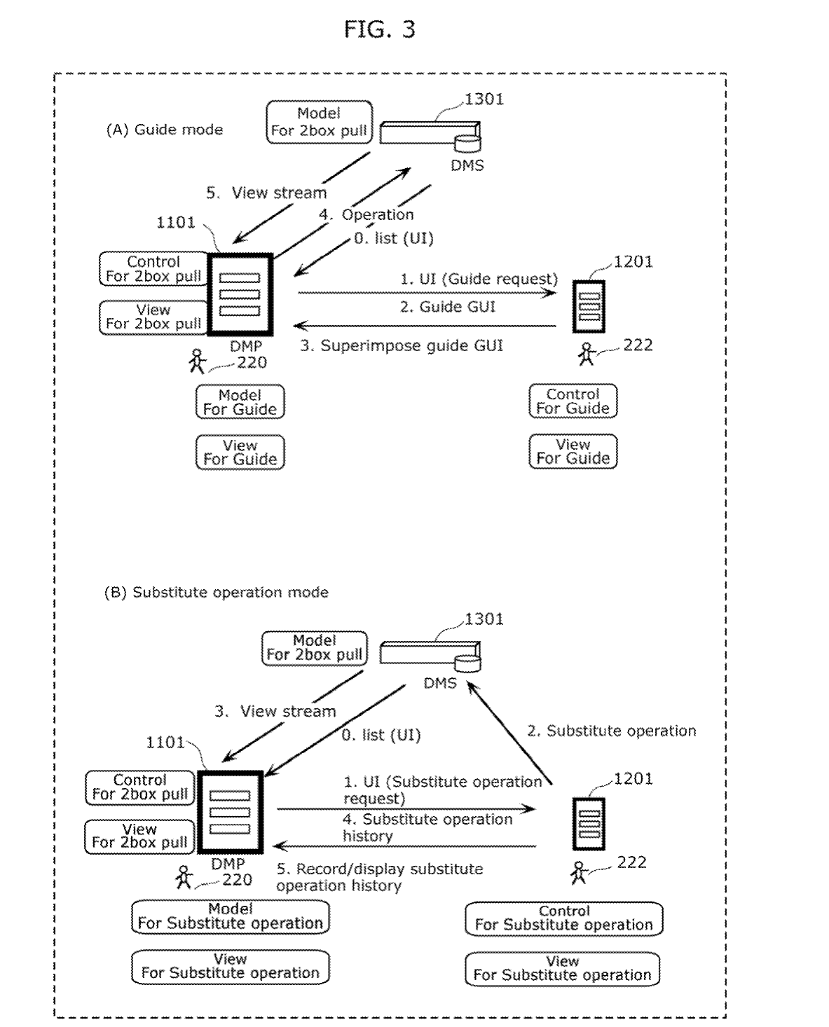

The inter-apparatus guide system 1001 may have a first structure in which the operation target apparatus 1301 is present in the same terminal as the supported apparatus 1101 as shown in FIG. 2, or a second structure in which the operation target apparatus 1301 is present in a terminal different from the supported apparatus 1101 as shown in FIG. 3. In the case where the operation target apparatus 1301 is present in the same terminal as the supported apparatus 1101, the network connection between the supported device 1101 and the operation target apparatus 1301 is unnecessary.

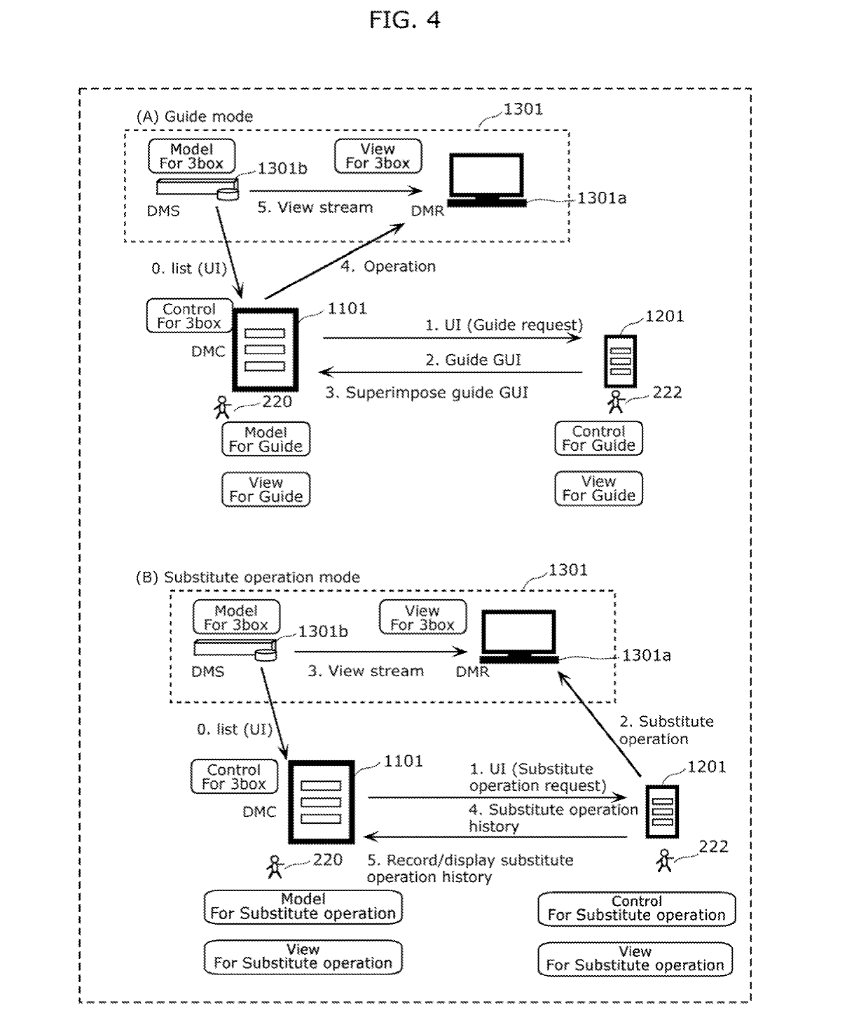

Alternatively, the inter-apparatus guide system 1001 may have a third structure in which there are two or more operation target apparatuses 1301, such as operation target apparatuses 1301a and 1301b, which are present in different terminals as shown in FIG. 4.

An example of the first structure is the following situation. As shown in FIG. 2, from a smartphone as the supporting apparatus 1201, the supporting user 222 supports (guides or substitutes for) the supported user 220 in an operation of reproducing, on a tablet terminal as the supported apparatus 1101, photos recorded in the tablet terminal. In such a case, the supported apparatus 1101 and the operation target apparatus 1301 are included in one tablet terminal.

An example of the second structure is the following situation. As shown in FIG. 3, from a smartphone as the supporting apparatus 1201, the supporting user 222 supports (guides or substitutes for) the supported user 220 in an operation of viewing, on a tablet terminal as the supported apparatus 1101, content recorded in a recorder as the operation target apparatus 1301. In such a case, the supported apparatus 1101 is included in the tablet terminal, and the operation target apparatus 1301 is included in the recorder terminal.

An example of the third structure is the following situation. As shown in FIG. 4, from a smartphone as the supporting apparatus 1201, the supporting user 222 supports (guides or substitutes for) the supported user 220 in an operation of, in order to view content recorded in a recorder as one operation target apparatus 1301 on a TV as another operation target terminal 1301, controlling the TV from a tablet terminal as the supported apparatus 1101. In such a case, the supported apparatus 1101 is included in the tablet terminal for controlling the TV, the first operation target apparatus 1301a is included in the recorder, and the second operation target terminal 1301b is included in the TV.

The following describes an example of process flow of the inter-apparatus guide system 1001 in the embodiment of the present invention, using flowcharts.

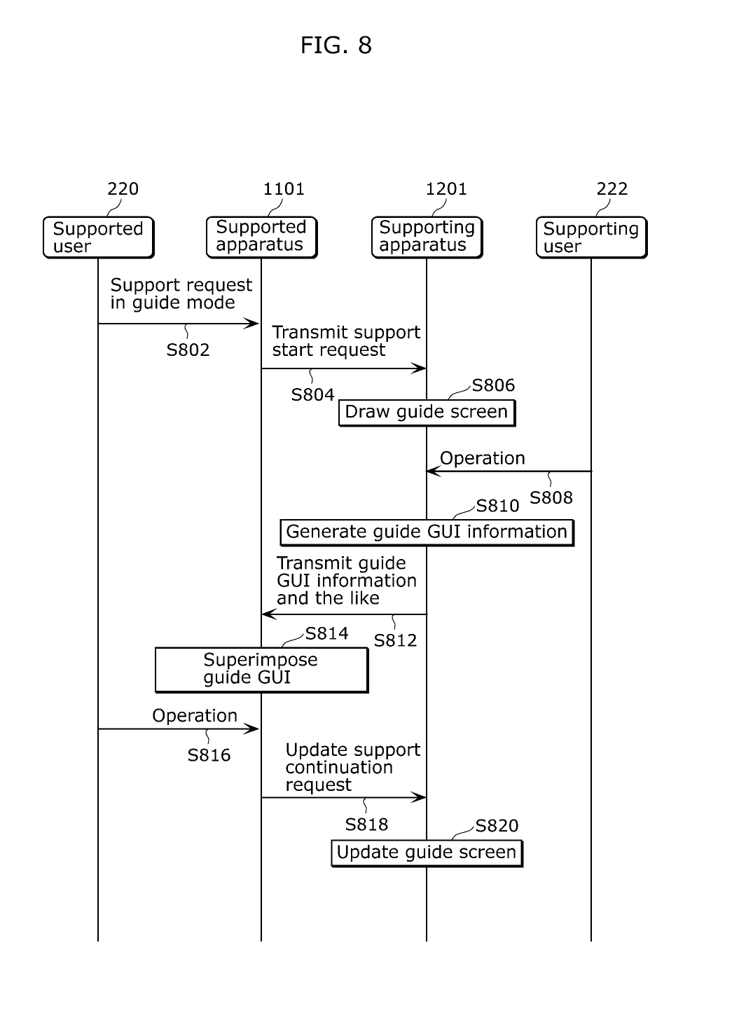

FIG. 8 is a sequence diagram between the supported apparatus 1101 and the supporting apparatus 1201 in the guide mode in the embodiment of the present invention.

As shown in FIG. 8, when the supported apparatus 1101 obtains the support request in the guide mode according to the input operation by the supported user 220 (Step S802), the supported apparatus 1101 transmits the support start request to the supporting apparatus 1201 (Step S804). The supported apparatus 1101 may transmit the support start request including the operation screen information and the like, or transmit the support start request and the operation screen information and the like separately.

Next, the supporting apparatus 1201 draws the guide screen on the input and output unit 822 (Step S806).

The supporting user 222 performs the operation for realizing what the supported user 220 wants, on the guide screen (Step S808).

The supporting apparatus 1201 generates the guide GUI information, from the operation performed by the supporting user 222 on the guide screen (Step S810). The generated guide GUI information is transmitted from the supporting apparatus 1201 to the supported apparatus 1101 (Step S812).

The supported apparatus 1101 displays the operation screen in which the guide GUI is superimposed on the operation item indicated by the guide GUI information (Step S814).

The supported user 220 performs the operation according to the guide GUI, on the operation screen on which the guide GUI is superimposed (Step S816).

The supported apparatus 1101 requests the supporting apparatus 1201 to continue the support. The supported apparatus 1101 may transmit the support continuation request including the operation screen information updated according to the operation by the supported user 220, or transmit the support continuation request and the updated operation screen information separately (Step S818).

The supporting apparatus 1201 updates the guide screen, by drawing the guide screen according to the obtained operation screen information as in Step S806 (Step S820).

Subsequently, the same steps are repeated until the support is stopped.

The process determination unit 1104 may stop the support at least one of: when a predetermined operation (e.g. a touch operation on a button to instruct stopping the support) is performed by the supported user 220; when a predetermined signal (e.g. a signal notifying the completion of the process desired by the supported user 220 such as reproducing photos) is received from the operation target apparatus 1301; when a predetermined signal (e.g. a signal notifying that the supporting user 222 touches a button for instructing stopping the support) is received from the supporting apparatus 1201; and when a predetermined time (e.g. a timeout period) elapses. For example, the process determination unit 1104 causes the guide GUI superimposition unit 1107 to stop superimposing the guide GUI, and transmits a support stop request to the operation target apparatus 1301.

The following describes more detailed flow.

### (Guide Mode: Supported Apparatus)

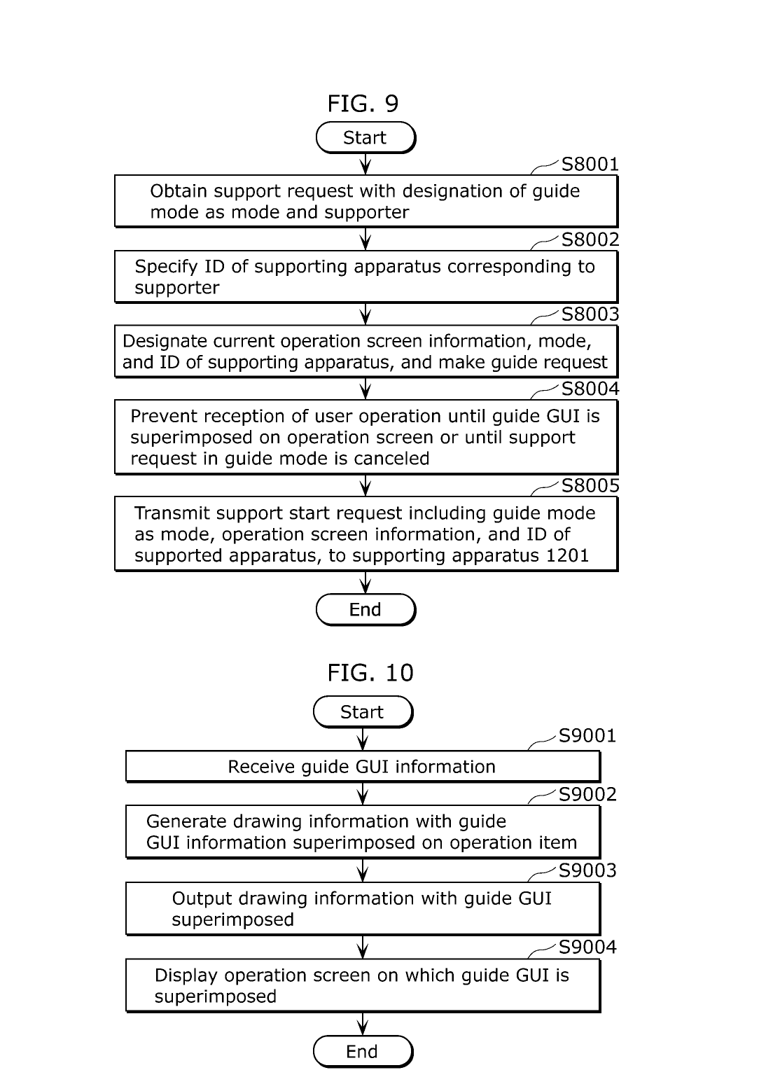

FIG. 9 is a detailed flowchart of the process of transmitting the support start request to the supporting apparatus 1201 (Steps S802 and S804 in FIG. 8).

In particular, FIG. 9 is a flowchart showing an example of the process of the supported apparatus 1101 when the supported user 220 of the supported apparatus 1101 requests support in the guide mode in the embodiment of the present invention.

When the supported user 220 performs the input operation of requesting support on the supported apparatus 1101 by designating the guide mode as the mode and Mr. A as the supporting user, the user input reception unit 1103 in the supported apparatus 1101 receives the user input from the input unit 1102, and notifies the process determination unit 1104 of the user input (Step S8001).

The process determination unit 1104 specifies that the input is the support request, and the mode is the guide mode. The process determination unit 1104 also specifies the supporting apparatus corresponding to Mr. A as the supporting user, from a database in which the supporting users 222 and the supporting apparatuses 1201 are associated with each other beforehand (Step S8002). The process determination unit 1104 then passes the guide mode as the mode and the ID of the supporting apparatus to the request issuance unit 1105, and requests support in the guide mode. An example of the method of determining whether the input is the support request or the operation request and whether the mode is the guide mode or the substitute operation mode in the case where the input is the support request has been described above with regard to the structure of the process determination unit 1104.

Upon receiving the support request in the guide mode, the request issuance unit 1105 passes the current operation screen information, the type of the mode, and the ID of the supporting apparatus to the transmission and reception unit 1106, and makes the guide request to the supporting apparatus 1201 (Step S8003).

The request issuance unit 1105 sets the process determination unit 1104 so as not to receive an operation request from the user until the guide GUI superimposition unit 1107 superimposes the guide GUI on the current operation screen based on the information from the supporting apparatus 1201 or until the support request in the guide mode is canceled (Step S8004).

Lastly, the transmission and reception unit 1106 in the supported apparatus 1101, when instructed by the request issuance unit 1105, transmits the support start request including the guide mode as the mode, the operation screen information, and the ID of the supported apparatus 1101 to the supporting apparatus 1201 (Step S8005).

FIG. 10 is a detailed flowchart of the process of superimposing the guide GUI by the supported apparatus 1101 (Step S814 in FIG. 8).

In particular, FIG. 10 is a flowchart showing an example of the process of the supported apparatus 1101 when the supported apparatus 1101 receives the guide GUI information from the supporting apparatus 1201 in response to the support request to the supporting apparatus 1201 in the embodiment of the present invention.

First, the transmission and reception unit 1106 in the supported apparatus 1101 receives the guide GUI information in the guide mode, from the supporting apparatus 1201 (Step S9001). The transmission and reception unit 1106 provides the guide GUI information to the guide GUI superimposition unit 1107.

Upon receiving the guide GUI information from the transmission and reception unit 1106, the guide GUI superimposition unit 1107 generates the drawing information of the operation screen in which the guide GUI specified by the guide GUI information is superimposed on the operation item, and requests the screen output control unit 1108 to output the drawing information (Step S9002).

Upon receiving the drawing instruction from the guide GUI superimposition unit 1107, the screen output control unit 1108 updates the drawing information of the operation screen based on the received drawing information, and outputs it to the output unit 1109 (Step S9003).

Lastly, the output unit 1109 displays the operation screen received from the screen output control unit 1108 (Step S9004).

The displayed operation screen on which the guide GUI is superimposed is shown, for example, in FIG. 6 described above.

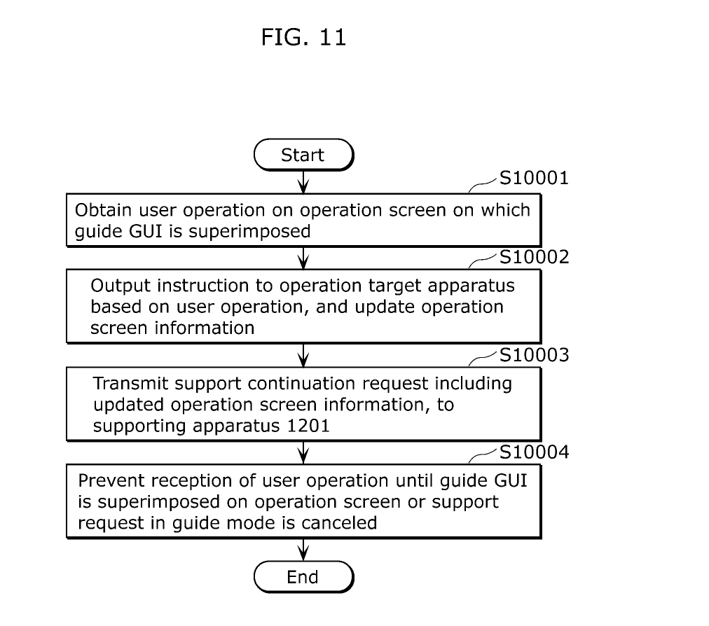

FIG. 11 is a detailed flowchart of the process of making the support continuation request from the supported apparatus 1101 to the supporting apparatus 1201 (Steps S816 and S818 in FIG. 8).

In particular, FIG. 11 is a flowchart showing an example of the process of the supported apparatus 1101 when the supported user 220 of the supported apparatus 1101 operates the operation screen on which the guide GUI is superimposed during the use of the support in the guide mode in the embodiment of the present invention.

First, when the supported user 220 who uses the supported apparatus 1101 operates the operation screen on which the guide GUI is superimposed during the use of the support in the guide mode, the user input reception unit 1103 obtains the user operation from the input unit 1102 (Step S10001). The user input reception unit 1103 notifies the process determination unit 1104 of the user input.

Upon receiving the operation request on the operation screen on which the guide GUI is superimposed in the guide mode, the process determination unit 1104 passes the information of the operation to the operation execution unit 1110, and instructs the operation target apparatus to execute the process. The process determination unit 1104 also notifies the request issuance unit 1105 of the update of the operation screen, thus updating the operation screen information (Step S10002).

When notified of the update of the operation screen from the process determination unit 1104, the request issuance unit 1105 passes the updated operation screen information to the transmission and reception unit 1106, to transmit the signal for requesting the continuation of the support in the guide mode to the supporting apparatus 1201 (Step S10003). Further, the request issuance unit 1105 again sets the process determination unit 1104 so as not to receive an operation request from the user until the guide GUI is superimposed on the operation screen or until the support request in the guide mode is canceled (Step S10004).

### (Guide Mode: Supporting Apparatus)

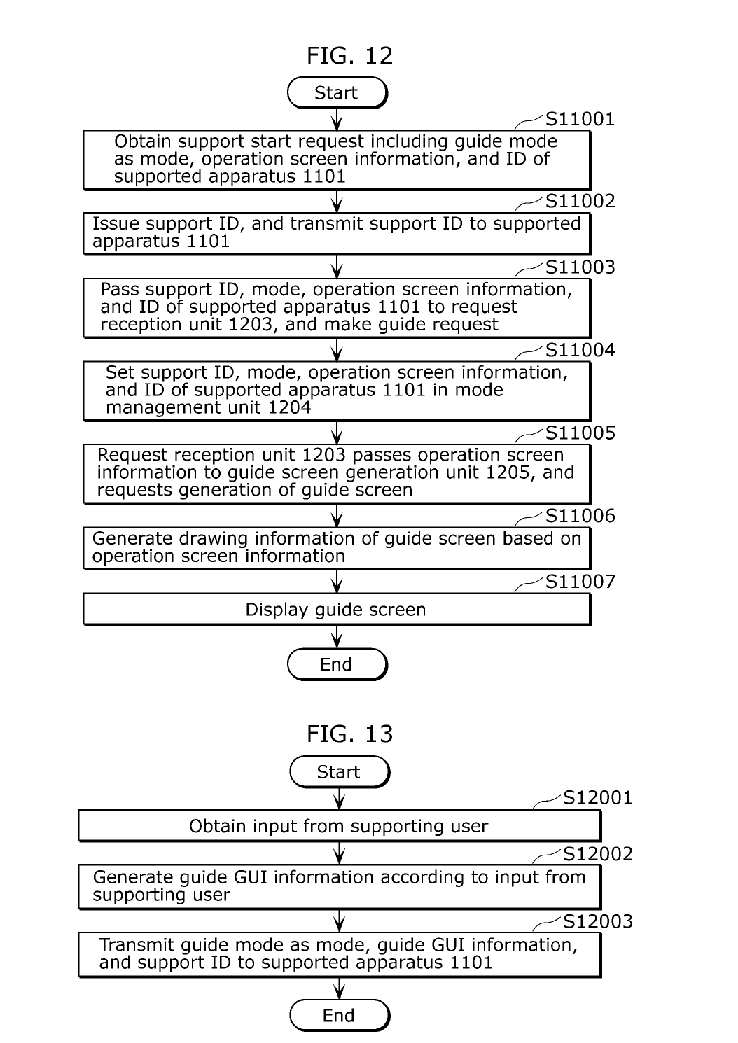

FIG. 12 is a detailed flowchart of the process of drawing the guide screen by the supporting apparatus 1201 (Step S806 in FIG. In particular, FIG. 12 is a flowchart showing an example of the process of the supporting apparatus 120 when the supporting apparatus 1201 receives the support request in the guide mode in the embodiment of the present invention.

First, the transmission and reception unit 1202 in the supporting apparatus 1201 receives the support start request designating the guide mode as the mode, the operation screen information, and the ID of the supported apparatus 1101, from the supported apparatus 1101 (Step S11001). The transmission and reception unit 1202 then issues the support ID, and transmits the support ID to the supported apparatus 1101 (Step S11002). The transmission and reception unit 1202 also passes the received support ID, mode, operation screen information, and ID of the supported apparatus 1101 to the request reception unit 1203, and makes the support request in the guide mode (guide request) (Step S11003).

The request reception unit 1203 sets the support ID, the mode, the operation screen information, and the ID of the supported apparatus 1101 in the mode management unit 1204 by recording these information (Step S11004). The request reception unit 1203 also passes the operation screen information to the guide screen generation unit 1205, and requests the generation of the guide screen (Step S11005).

When instructed to generate the guide screen by the request reception unit 1203, the guide screen generation unit 1205 generates the drawing information of the guide screen using the operation screen information received from the supported apparatus 1101 (Step S11006), and requests the screen output control unit 1207 to output the screen.

Lastly, the screen output control unit 1207 outputs the drawing information for the output unit 1208 to display the guide screen, to the output unit 1208 (Step S11007).

FIG. 13 is a detailed flowchart of the process of transmitting the guide GUI information from the supporting apparatus 1201 to the supported apparatus 1101 (Step S812 in FIG. 8).

In particular, FIG. 13 is a flowchart showing an example of the process of the supporting apparatus 1201 when the supporting apparatus 1201 receives the guide input from the user on the output guide screen in the embodiment of the present invention.

First, the user input reception unit 1210 in the supporting apparatus 1201 receives the user input from the input unit 1209 (Step S12001). The user input reception unit 1210 notifies the process determination unit 1211 of the user input.

The process determination unit 1211 requests the guide GUI generation unit 1212 to generate the guide GUI information, in the case where the type of the mode is the guide mode (Step S12002). When instructed by the process determination unit 1211, the guide GUI generation unit 1212 generates the guide GUI information.

Lastly, the guide GUI generation unit 1212 passes the guide mode as the mode, the guide GUI information, and the support ID to the transmission and reception unit 1202, and requests the transmission and reception unit 1202 to transmit the guide GUI to the supported apparatus 1101, as a result of which the guide GUI information and the like are transmitted to the supported apparatus 1101 (Step S12003).

This completes the description of the process flow of the supported apparatus 1101 and the supporting apparatus 1201 in the guide mode.

The following describes process flow of the supported apparatus 1101 and the supporting apparatus 1201 in the substitute operation mode.

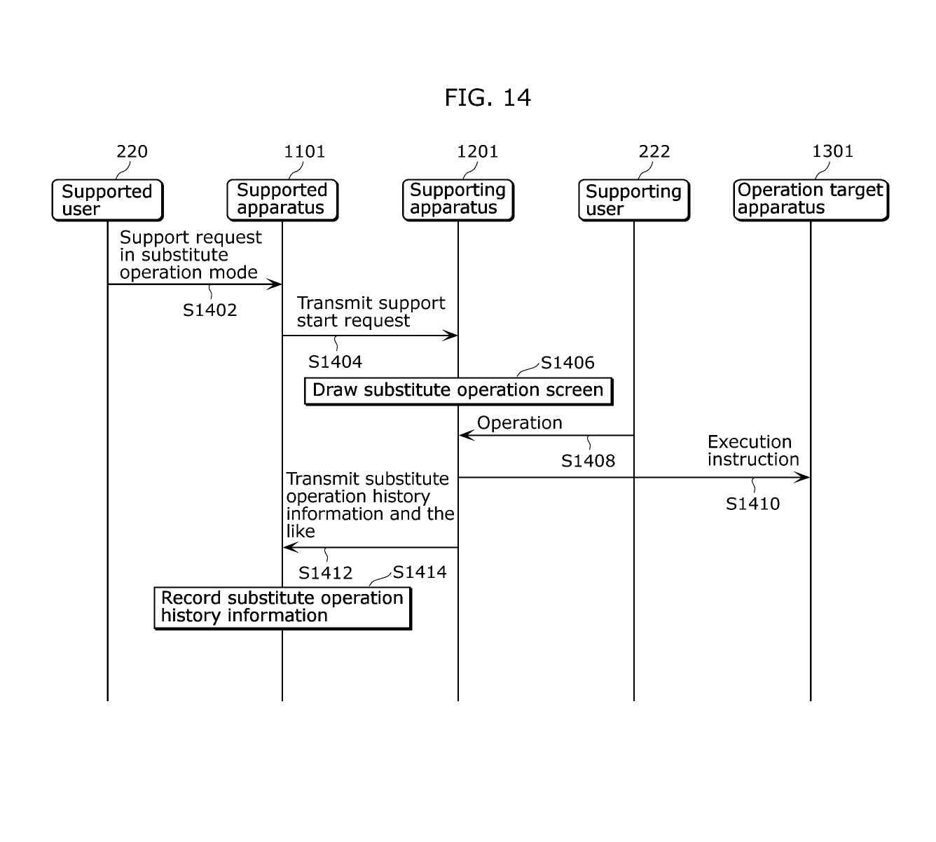

FIG. 14 is a sequence diagram between the supported apparatus 1101, the supporting apparatus 1201, and the operation target apparatus 1301 in the substitute operation mode in the embodiment of the present invention.

As shown in FIG. 14, when the supported user 220 requests support in the substitute operation mode on the supported apparatus 1101 (Step S1402), the supported apparatus 1101 transmits the support start request including the operation screen information and the like, to the supporting apparatus 1201 (Step S1404).

The supporting apparatus 1201 draws the substitute operation screen on the input and output unit 822 to display it, based on the received operation screen information (Step S1406).

The supporting user 222 performs, on the substitute operation screen, the operation for realizing what the supported user 220 wants in the supported apparatus 1101, which has been informed from the supported user 220 beforehand (Step S1408).

The supporting apparatus 1201 transmits the instruction to execute the process corresponding to the operation performed by the supporting user 222, to the operation target apparatus 1301 (Step S1410). The supporting apparatus 1201 also transmits the substitute operation history information indicating the history of the operation performed by the supporting user 222 in Step S1408, to the supported apparatus 1101 (Step S1412).

The supported apparatus 1101 records the received substitute operation history information so that the supported user 220 can learn how to operate the supported apparatus 1101 (Step S1414). For example, the recorded substitute operation history information is reproduced on the supported apparatus 1101 according to the operation by the supported user 220.

The following describes more detailed flow.

### (Substitute Operation Mode: Supported Apparatus)

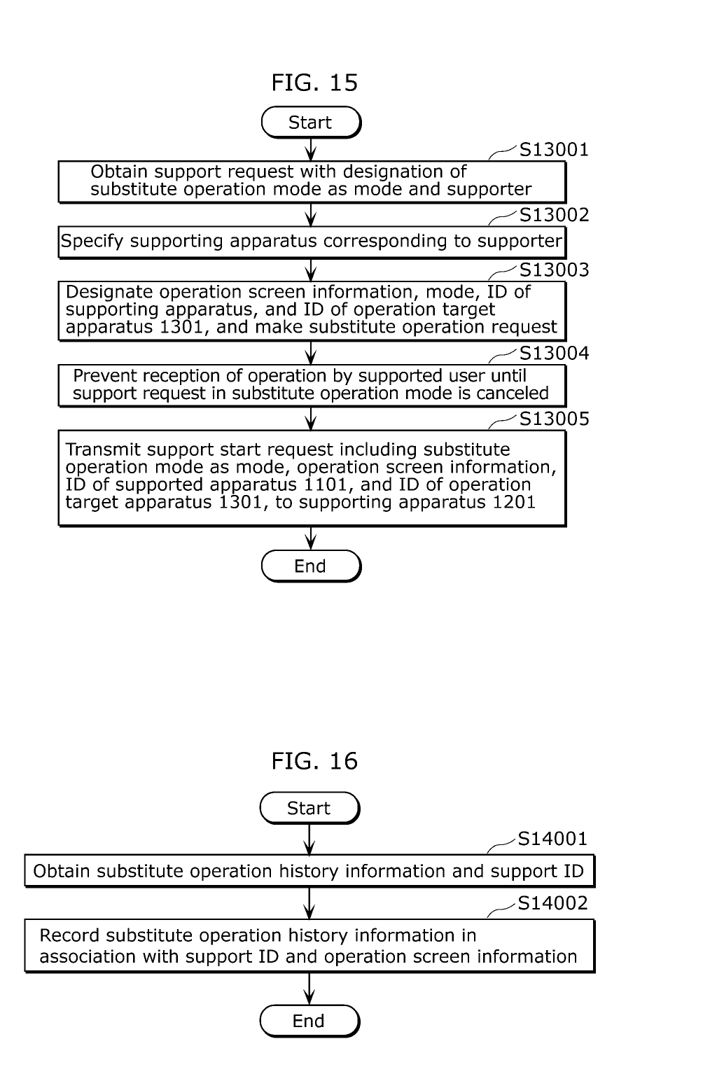

FIG. 15 is a detailed flowchart of the process of transmitting the support start request from the supported apparatus 1101 to the supporting apparatus 1201 (Steps S1402 and S1404 in FIG. 14).

In particular, FIG. 15 is a flowchart showing an example of the process of the supported apparatus 1101 when the supported user 220 of the supported apparatus 1101 requests support in the substitute operation mode in the embodiment of the present invention.

First, when the supported user 220 makes the support request by designating the substitute operation mode as the mode and Mr. A as the supporting user, the user input reception unit 1103 in the supported apparatus 1101 obtains the support request by the user from the input unit 1102 (Step S13001). The input unit 1102 notifies the process determination unit 1104 of the support request by the user.

The process determination unit 1104 specifies that the input is the support request, and the mode is the substitute operation mode. The process determination unit 1104 also specifies the supporting apparatus 1201 to which the support start request is to be transmitted, by obtaining, from the database, the identifier for identifying the supporting apparatus associated with the supporting user beforehand (Step S13002).

The process determination unit 1104 then passes the specified type of the mode (substitute operation mode) and the ID of the supporting apparatus to the request issuance unit 1105, and requests the request issuance unit 1105 to issue the support start request in the substitute operation mode (also referred to as “substitute operation request”) (Step S13003). An example of the method of determining whether the input is the support request or the operation request for operating the supported apparatus 1101 by the supported user 220, whether the mode is the guide mode or the substitute operation mode in the case where the input is the support request, and which apparatus is the supporting apparatus has been described above with regard to the structure of the process determination unit 1104.

Upon receiving the support request in the substitute operation mode, the request issuance unit 1105 sets the process determination unit 1104 so as not to receive an operation request from the user until the support request in the substitute operation mode is canceled (Step S13004). The request issuance unit 1105 also passes the current operation screen information, the mode, the ID of the supporting apparatus, and the ID of the operation target apparatus 1301 to the transmission and reception unit 1106, and issues the support start request in the substitute operation mode to the supporting apparatus 1201.

Lastly, the transmission and reception unit 1106 in the supported apparatus 1101, when the support start request is issued by the request issuance unit 1105, transmits the substitute operation mode as the mode, the operation screen information, the ID of the supported apparatus 1101, and the ID of the operation target apparatus 1301 to the supporting apparatus 1201, thus requesting the supporting apparatus 1201 to start the support (Step S13005).

FIG. 16 is a detailed flowchart of the process of recording the substitute operation history information by the substitute history recording unit 1111 in the supported apparatus 1101 (Steps S1412 and S1414 in FIG. 14).

In particular, FIG. 16 is a flowchart showing an example of the process of the supported apparatus 1101 when the supported apparatus 1101 receives the substitute operation history information from the supporting apparatus 1201 in response to the support start request to the supporting apparatus 1201 in the embodiment of the present invention.

First, the transmission and reception unit 1106 in the supported apparatus 1101 receives the substitute operation history information and the support ID in the substitute operation mode (Step S14001). The transmission and reception unit 1106 provides the obtained mode, substitute operation history information, and support ID to the substitute history recording unit 1111.

Upon receiving the substitute operation history information from the transmission and reception unit 1106, the substitute history recording unit 111 records the substitute operation history information in association with the support ID and the operation screen information (Step S14002).

In detail, the substitute operation history information includes information indicating which operation items included in the substitute operation screen displayed on the supporting apparatus 1201 are operated by the supporting user 222 in which sequence. The information includes, for example, the unique identifiers assigned to the operation items and the operation sequence of the operation items. Moreover, the operation screen information includes information indicating which operation items are displayed on the substitute operation screen during the operation by the supporting user 222. The information includes, for example, the list of the identifiers of the displayed operation items, the display areas of the operation items, and the default values of the operation items.

Accordingly, when the supported user 220 designates the support ID and instructs the supported apparatus 1101 to reproduce the substitute operation history information, the supported apparatus 1101 can recreate, on the operation screen of the supported apparatus 1101, the operation performed by the supporting user 222 on the substitute operation screen, based on the substitute operation history information and the operation screen information.

### (Substitute Operation Mode: Supporting Apparatus)

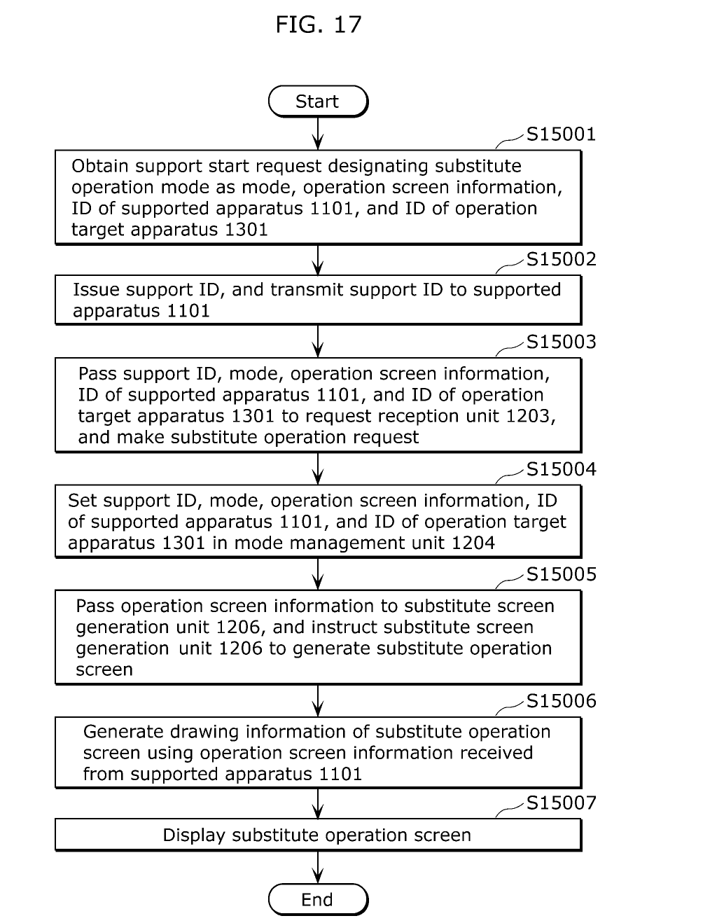

FIG. 17 is a detailed flowchart of the process of displaying the substitute operation screen by the supporting apparatus 1201 (Step S1406 in FIG. 14).

In particular, FIG. 17 is a flowchart showing an example of the process of the supporting apparatus 120 when the supporting apparatus 1201 receives the support request in the substitute operation mode in the embodiment of the present invention.

First, the transmission and reception unit 1202 in the supporting apparatus 1201 receives the support start request designating the substitute operation mode as the mode, the operation screen information, the ID of the supported apparatus 1101, and the ID of the operation target apparatus 1301, from the supported apparatus 1101 (Step S15001). The transmission and reception unit 1202 then issues the support ID, and transmits the support ID to the supported apparatus 1101 (Step S15002). The transmission and reception unit 1202 also passes the support ID, the mode, the operation screen information, the ID of the supported apparatus 1101, and the ID of the operation target apparatus 1301 to the request reception unit 1203, and makes the substitute operation request (Step S15003).

The request reception unit 1203 sets the support ID, the mode, the operation screen information, the ID of the supported apparatus 1101, and the ID of the operation target apparatus 1301 in the mode management unit 1204 by recording these information (Step S15004). The request reception unit 1203 also passes the operation screen information to the substitute screen generation unit 1206, and instructs the substitute screen generation unit 1206 to generate the substitute operation screen (Step S15005).

When instructed to generate the substitute operation screen by the request reception unit 1203, the substitute screen generation unit 1206 generates the drawing information of the substitute operation screen based on the operation screen information received from the supported apparatus 1101 (Step S15006). The substitute screen generation unit 1206 then requests the screen output control unit 1207 to output the screen of the drawing information.

Lastly, the screen output control unit 1207 displays the substitute operation screen on the output unit 1208 (Step S15007).

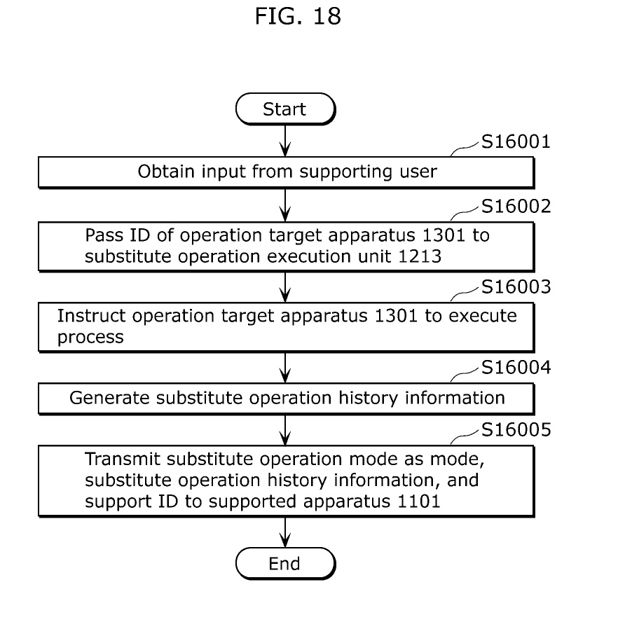

FIG. 18 is a detailed flowchart of the process of transmitting the substitute operation history information from the supporting apparatus 1201 to the supported apparatus 1101 (Step S1412 in FIG. 14).

In particular, FIG. 18 is a flowchart showing an example of the process of the supporting apparatus 1201 when the supporting apparatus 1201 receives the substitute operation input from the supporting user 222 on the output substitute operation screen in the embodiment of the present invention.

First, the user input reception unit 1210 in the supporting apparatus 1201 receives the user input from the input unit 1209 (Step S16001). The user input reception unit 1210 notifies the process determination unit 1211 of this input by the supporting user 222.

The process determination unit 1211 passes the ID of the operation target apparatus 1301 to the substitute operation execution unit 1213 (Step S16002), and instructs the substitute operation execution unit 1213 to execute the process corresponding to the input by the supporting user 222.

When instructed by the process determination unit 1211, the substitute operation execution unit 1213 transmits the signal of the instruction to execute the requested process, to the operation target apparatus 1301 (Step S16003). The substitute operation execution unit 1213 also instructs the substitute history generation unit 1214 to generate the substitute operation history information.

When instructed by the substitute operation execution unit 1213, the substitute history generation unit 1215 generates the substitute operation history information (Step S16004). After this, the substitute history generation unit 1214 passes the substitute operation mode as the mode, the substitute operation history information, and the support ID to the transmission and reception unit 1202, and requests the transmission and reception unit 1202 to transmit the substitute operation history information to the supported apparatus 1101.

Lastly, the transmission and reception unit 1202 transmits the substitute operation history information and the like obtained from the substitute history generation unit 1214, to the supported apparatus 1101 (Step S16005).

With this structure, the inter-apparatus guide system 1001 in the embodiment of the present invention achieves the following features (1) to (3).

(1) The guide mode or the substitute operation mode can be selected. In the guide mode, the guide GUI is generated by the operation performed on the supporting apparatus, and superimposed on the supported apparatus. The supported apparatus executes the process according to the operation by the user of the supported apparatus.

(2) The UI is bidirectionally communicated between the apparatuses. This enables the user to learn the operation while checking the guide step by step.

(3) In the case where there is a difference in screen resolution, component size, or arrangement between the supported apparatus and the supporting apparatus, the guide GUI associated with the component is converted according to the screen resolution, the component size, or the arrangement, and the converted guide GUI is superimposed. Through such operation component-based guide, the user of the supported apparatus who is unaccustomed to operate home appliances can be given opportunities to learn the operation while communicating with the user of the supporting apparatus.

Hence, it is possible to provide a supported apparatus and the like that enable a supported user to receive interactive operation support from a supporting user regardless of display devices, without being deprived of learning opportunities.

Moreover, in the substitute operation mode, the supporting apparatus substitutes for the supported apparatus to directly control an apparatus which is subject to DLNA 2Box/3Box control, with it being possible to reduce the processing delay. In detail, in the case of supporting control of a remote apparatus by Remote Desktop which is one of the conventional techniques, the supporting apparatus operates the supported apparatus which is a remote apparatus. This causes a problem of an increase in processing delay, as the remote operation is conducted via two apparatuses. For example, such a problem of processing delay occurs in the case where the supported apparatus is a tablet terminal having a control function (DMC: Digital Media Controller) of DLNA (Digital Living Network Alliance), and this tablet terminal is used to perform control (3-Box control) to select content recorded in a recorder which is a DLNA server (DMS: Digital Media Server) and play the content on a TV which is a DLNA renderer (DMR: Digital Media Renderer).

In the case where the inter-apparatus guide system 1001 in this embodiment is used in the substitute operation mode, the supporting apparatus 1201 substitutes for the supported apparatus 1101 to directly control the operation target apparatus 1301 which is subject to DLNA 2-Box/3-Box control. The processing delay can be reduced in this way.

Though the transmission and reception unit 1106 is included as the communication interface in the supported apparatus 1101 in this embodiment, a transmission unit and a reception unit may be provided as separate structural elements. Likewise, not the transmission and reception unit 1202 but a transmission unit and a reception unit may be provided as separate structural elements as the communication interface in the supporting apparatus 1201.

Though the input unit 1102 and the output unit 1109 are integrated as the input and output nit 812 such as a touch display in this embodiment, the input unit 1102 and the output unit 1109 may be separate interfaces. For example, a liquid crystal display may be used in the output unit 1109, and a mouse, a track pad, and the like in the input unit 1102. Likewise, the output unit 1208 and the input unit 1209 may be separate interfaces. For example, a liquid crystal display may be used in the output unit 1208, and a mouse, a track pad, and the like in the input unit 1209.

Note that, in the case where the guide GUI information includes a plurality of operation items and information for specifying the operation sequence of the plurality of operation items, the guide GUI superimposition unit 1107 may superimpose the guide GUI corresponding to each of the plurality of operation items on the operation screen together with the image indicating the ordinal position of the operation item in the operation sequence.

This is described in detail below, with reference to (e) and (f) in FIG. 6.

As mentioned earlier, when the supporting user 222 touches the button P001, the button P003, and the “OK” button 6207 on the substitute operation screen in this order, the guide GUI information includes the operation items corresponding to the three button operations and the operation sequence of the operation items.

Having obtained the guide GUI information, the guide GUI superimposition unit 1107 may superimpose, at the upper left of the button P001 displayed on the operation screen, an image (e.g. an image showing “1”) indicating that the button is to be operated first, and also display the guide GUI 6202 as an image representing the frame around the button P001. Likewise, the guide GUI superimposition unit 1107 may superimpose, at the upper left of the button P003 displayed on the operation screen, an image (e.g. an image showing “2”) indicating that the button is to be operated second, and also display the guide GUI 6203 as an image representing the frame around the button P003. Further, the guide GUI superimposition unit 1107 may superimpose, at the upper left of the “OK” button, an image (e.g. an image showing “3”) indicating that the button is to be operated third, and also display the guide GUI 6204 as an image representing the frame around the “OK” button.

Note that the supported apparatus 1101 and the supporting apparatus 1201 achieve the same advantageous effects of the present invention even when not all of the above-mentioned structural elements are included.

For example, the supported user 220 may operate the operation target apparatus 1301 directly (i.e. from an input device included in the operation target apparatus 1301), with reference to the guide GUI displayed on the supported apparatus 1101. In this case, the advantageous effects of the present invention are achieved without the supported user 220 performing the input operation on the supported apparatus 1101, so that the input unit 1102 and the user input reception unit 1103 may be omitted from the supported apparatus 1101. Since the supported user 220 directly operates the operation target apparatus 1301, the operation execution unit 1110 may be omitted, too. Moreover, if the supported apparatus 1101 always operates in one of the guide mode and the substitute operation mode, the process determination unit 1104 may be omitted from the supported apparatus 1101. In this case, there is only one line of output to the output unit 1109, and so the screen output control unit 1108 may be omitted from the supported apparatus 1101. Especially if the supported apparatus 1101 always operates in the guide mode, the substitute history recording unit 1111 may be omitted from the supported apparatus 1101.

In the case where the supported apparatus 1101 does not have the substitute operation mode and always operates in the guide mode, the supporting apparatus 1201 may always operate in the substitute operation mode. In this case, the same advantageous effects of the present invention are achieved even when the supporting apparatus 1201 does not include the screen output control unit 1207, the substitute screen generation unit 1206, the mode management unit 1204, the substitute operation execution unit 1213, and the substitute history generation unit 1214.

The functional blocks included in each of the supporting apparatus and the supported apparatus shown in FIG. 1 are typically realized as LSI which is an integrated circuit. The functional blocks may each be individually implemented as one chip, or may be partly or wholly implemented on one chip.

In detail, of the functional blocks in the supported apparatus 1101 shown in FIG. 1, the user input reception unit 1103, the process determination unit 1104, the request issuance unit 1105, the transmission and reception unit 1106, the guide GUI superimposition unit 1107, the screen output control unit 1108, and the operation execution unit 1110 may be partly or wholly realized as an integrated circuit.

Likewise, of the functional blocks in the supporting apparatus 1201 shown in FIG. 1, the transmission and reception unit 1202, the request reception unit 1203, the mode management unit 1204, the guide screen generation unit 1205, the substitute screen generation unit 1206, the screen output control unit 1207, the user input reception unit 1210, the process determination unit 1211, the guide GUI generation unit 1212, the substitute history generation unit 1214, and the substitute operation execution unit 1213 may be partly or wholly realized as an integrated circuit.

Though LSI is mentioned here, the integrated circuit may be called IC, system LSI, super LSI, or ultra LSI, depending on the degree of integration.

Moreover, the integrated circuit technology is not limited to LSI, and may be realized by a dedicated circuit or a general-purpose processor. An FPGA (Field Programmable Gate Array) which can be programmed or a reconfigurable processor which is capable of reconfiguring connections and settings of circuit cells in LSI after LSI manufacturing may be used.

Furthermore, when an integrated circuit technology that replaces LSI emerges from development of semiconductor technologies or other derivative technologies, such a technology may be used to integrate the functional blocks. For instance, biotechnology may be adapted in this way.

Of the structural elements in the user interaction device, the data storage means may be provided as a separate structure without being included in the chip.

The present invention may be realized not only as a display apparatus or an operation apparatus, but also as a method including steps corresponding to the processing units included in the display apparatus or the operation apparatus. The present invention may also be realized as a program for causing a computer to execute the steps included in the method. The present invention may further be realized as a computer-readable recording medium such as a CD-ROM storing the program.

In detail, of the functional blocks in the supported apparatus 1101 shown in FIG. 1, a program for executing part or all of the processes of the user input reception unit 1103, the process determination unit 1104, the request issuance unit 1105, the transmission and reception unit 1106, the guide GUI superimposition unit 1107, the screen output control unit 1108, and the operation execution unit 1110 may be stored in a ROM 46, a RAM 48, a hard disk 50, or the like and executed by a CPU 44 described later.

Likewise, of the functional blocks in the supporting apparatus 1201 shown in FIG. 1, a program for executing part or all of the processes of the transmission and reception unit 1202, the request reception unit 1203, the mode management unit 1204, the guide screen generation unit 1205, the substitute screen generation unit 1206, the screen output control unit 1207, the user input reception unit 1210, the process determination unit 1211, the guide GUI generation unit 1212, the substitute history generation unit 1214, and the substitute operation execution unit 1213 may be stored in the ROM 46, the RAM 48, the hard disk 50, or the like and executed by the CPU 44 described later.

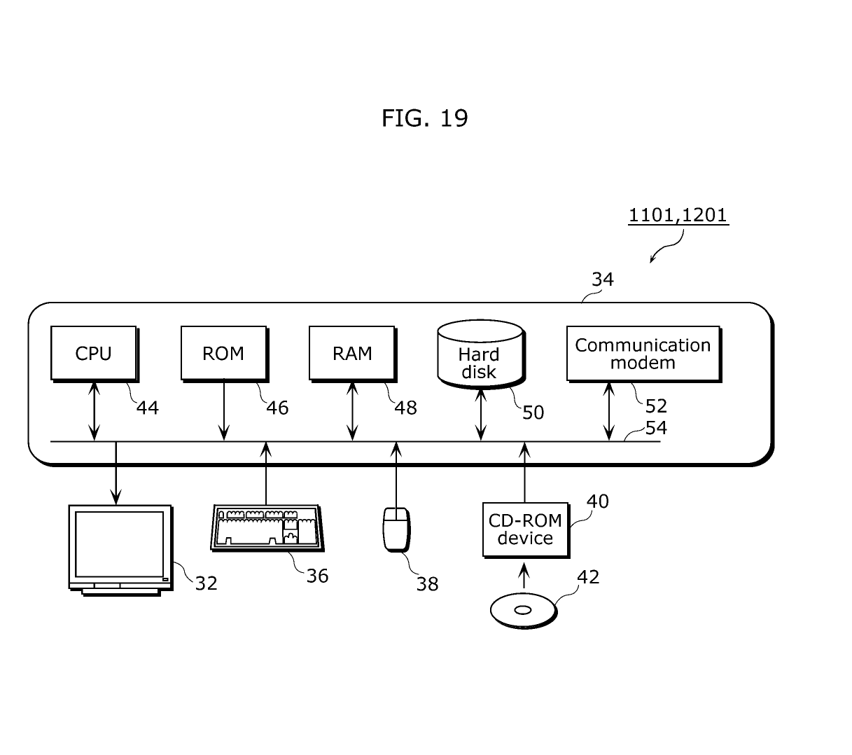

The supported apparatus 1101 and the supporting apparatus 1201 described in this embodiment may also be realized by a computer. FIG. 19 is a block diagram showing a hardware structure of a computer system that realizes the supported apparatus 1101 and the supporting apparatus 1201.

The supported apparatus 1101 and the supporting apparatus 1201 each include a computer 34, a keyboard 36 and a mouse 38 for instructing the computer 34, a display 32 for presenting information of computation results of the computer 34 and the like, a CD-ROM device 40 for reading a program executed by the computer 34, and a communication modem (not shown).

The program representing the processes performed by each of the supported apparatus 1101 and the supporting apparatus 1201 is stored in a CD-ROM 42 which is a computer-readable medium, and read by the CD-ROM device 40. Alternatively, the program is read by a communication modem 52 via a computer network.

The computer 34 includes the CPU (Central Processing Unit) 44, the ROM (Read Only Memory) 46, the RAM (Random Access Memory) 48, the hard disk 50, the communication modem 52, and a bus 54.

The CPU 44 executes the program read via the CD-ROM device 40 or the communication modem 52. The ROM 46 stores programs and data necessary for the operation of the computer 34. The RAM 48 stores data such as parameters during program execution. The hard disk 50 stores programs and data. The communication modem 52 communicates with other computers via the computer network. The bus 54 connects the CPU 44, the ROM 46, the RAM 48, the hard disk 50, the communication modem 52, the display 32, the keyboard 36, the mouse 38, and the CD-ROM device 40 to each other.

The structural elements included in each of the apparatuses described above may be partly or wholly realized by one system LSI (Large Scale Integrated Circuit). The system LSI is ultra-multifunctional LSI produced by integrating a plurality of components on one chip, and is actually a computer system that includes a microprocessor, a ROM, a RAM, and the like. A computer program is stored in the RAM. The functions of the system LSI are achieved by the microprocessor operating according to the computer program.

The structural elements included in each of the apparatuses described above may be partly or wholly realized by an IC card or a single module that is removably connectable to the apparatus. The IC card or the module is a computer system that includes a microprocessor, a ROM, a RAM, and the like. The IC card or the module may include the above-mentioned ultra-multifunctional LSI. The functions of the IC card or the module are achieved by the microprocessor operating according to the computer program. The IC card or the module may be tamper resistant.

The present invention may also be the method described above. The present invention may also be a computer program that realizes the method by a computer. The present invention may also be a digital signal including the computer program.

The present invention may also be a computer-readable recording medium, such as a flexible disk, a hard disk, a CD-ROM, an MO, a DVD, a DVD-ROM, a DVD-RAM, a BD (Blu-ray Disc®), a USB memory, a memory card such as an SD card, or a semiconductor memory, on which the computer program or the digital signal is recorded. Conversely, the present invention may be the digital signal recorded on such a recording medium.

The present invention may also be the computer program or the digital signal transmitted via an electric communication line, a wired or wireless communication line, a network such as the Internet, data broadcasting, and the like.

The present invention may also be a computer system that includes a microprocessor and a memory. In this case, the computer program may be stored in the memory, with the microprocessor operating according to the computer program.

The computer program or the digital signal may be provided to another independent computer system by distributing the recording medium on which the computer program or the digital signal is recorded, or by transmitting the computer program or the digital signal via the network and the like. The independent computer system may then execute the computer program or the digital signal to function as the present invention.

The above embodiment and variations may be freely combined.

The embodiment disclosed herein is to be considered as in all aspects illustrative and not restrictive. The scope of the present invention is defined by the claims rather than by the description of the foregoing embodiment, and all modifications within the scope of the claims and within the meaning and scope of equivalence of the claims are intended to be included in the scope of the present invention

### INDUSTRIAL APPLICABILITY

The present invention is applicable to a supported apparatus and the like, and in particular to a supported apparatus and the like in an inter-apparatus guide system in which a supported user who operates a supported apparatus is supported by a supporting user through a supporting apparatus that is connected to the supported apparatus via a network.

### REFERENCE SIGNS LIST

32 Display
34 Computer
36 Keyboard
38 Mouse
40 CD-ROM device
42 CD-ROM
44 CPU
46 ROM
48 RAM
50 Hard disk
52 Communication modem
54 Bus
220 Supported user
222 Supporting user
812, 822 Input and output unit
1001 Inter-apparatus guide system
1101 Supported apparatus
1102, 1209 Input unit
1103, 1210 User input reception unit
1104, 1211 Process determination unit
1105 Request issuance unit
1106, 1202 Transmission and reception unit
1107 Guide GUI superimposition unit
1108, 1207 Screen output control unit
1109, 1208 Output unit
1110 Operation execution unit
1111 Substitute history recording unit
1201 Supporting apparatus
1203 Request reception unit
1204 Mode management unit
1205 Guide screen generation unit
1206 Substitute screen generation unit
1212 Guide GUI generation unit
1213 Substitute operation execution unit
1214 Substitute history generation unit
1301, 1301a, 1301b Operation target apparatus
1302 Process execution unit
6002, 6102, 6202, 6203, 6204 Guide GUI

1-18. (canceled)

19. A supported apparatus in an inter-apparatus guide system in which a supported user who operates the supported apparatus is supported by a supporting user through a supporting apparatus that is connected to the supported apparatus via a network, the supported apparatus comprising:
an output unit configured to display an operation screen which is an image including one or more operation items in the supported apparatus;
a request issuance unit configured to issue a support start request which is a signal including operation screen information for specifying the one or more operation items displayed on the operation screen;
a transmission and reception unit configured to transmit the support start request to the supporting apparatus, and receive guide graphical user interface (GUI) information from the supporting apparatus, the guide GUI information indicating an operation item to be operated by the supported user from among the one or more operation items;
a guide GUI superimposition unit configured to superimpose a guide GUI on the operation screen based on the guide GUI information, the guide GUI being an image for showing the supported user the operation item to be operated; and
a process determination unit configured to receive a support request from the supported user,
wherein the process determination unit is configured to determine a type of a mode of operation support designated by the supported user, when receiving the support request from the supported user,
the request issuance unit is configured to issue the support start request including the operation screen information and information indicating the determined type of the mode,
in the case where the type of the mode is determined as a first mode, the process determination unit is configured to cause the guide GUI superimposition unit to superimpose the guide GUI on the operation screen when the transmission and reception unit receives the guide GUI information, the output unit is configured to display the operation screen on which the guide GUI is superimposed, and the supported apparatus operates according to an operation performed by the supported user on the operation screen,
the supported apparatus further comprises
a substitute history recording unit configured to record substitute operation history information which is history information of an operation performed by the supporting user on the operation item displayed on the supporting apparatus, and
in the case where the type of the mode is determined as a second mode different from the first mode, the process determination unit is configured to cause the substitute history recording unit to record the substitute operation history information obtained from the supporting apparatus and the operation screen in association with each other, and the output unit is configured to, after a substitute operation by the supporting apparatus is performed, display the recorded substitute operation history information in association with the operation screen.

20. The supported apparatus according to claim 19,
wherein the guide GUI superimposition unit is configured to, in the case where the guide GUI information includes a plurality of operation items and information for specifying an operation sequence of the plurality of operation items, superimpose a guide GUI corresponding to each of the plurality of operation items on the operation screen together with an image indicating an ordinal position of the corresponding operation item in the operation sequence.

21. The supported apparatus according to claim 19,
wherein the guide GUI information indicates the operation item operated by the supporting user on a guide screen displayed on the supporting apparatus.

22. The supported apparatus according to claim 19, further comprising
an operation execution unit configured to transmit an operation signal for operating an external operation target apparatus, to the operation target apparatus,
wherein the process determination unit is configured to: cause the operation execution unit to transmit, to the operation target apparatus, the operation signal corresponding to the operation performed by the supported user on the operation screen; update the operation screen to conform to a result of a process executed by the operation target apparatus according to the operation signal; and cause the transmission and reception unit to transmit, to the supporting apparatus, the operation screen information indicating one or more operation items included in the updated operation screen.

23. The supported apparatus according to claim 22,
wherein the process determination unit is configured to cause the guide GUI superimposition unit to stop superimposing the guide GUI, at least one of: when a predetermined operation is performed by the supported user; when a predetermined signal is received from the operation target apparatus; when a predetermined signal is received from the supporting apparatus; and when a predetermined time elapses.

24. A supporting apparatus in an inter-apparatus guide system in which a supported user who operates a supported apparatus is supported by a supporting user through the supporting apparatus that is connected to the supported apparatus via a network, the supporting apparatus comprising:
a transmission and reception unit configured to receive operation screen information for specifying one or more operation items in the supported apparatus, from the supported apparatus;
a guide screen generation unit configured to generate a guide screen based on the operation screen information, the guide screen being an image including the one or more operation items;
an output unit configured to display the guide screen;
an input unit configured to obtain an operation performed by the supporting user on the guide screen; and
a guide GUI generation unit configured to generate guide graphical user interface (GUI) information indicating an operation item operated by the supporting user on the guide screen,
wherein the transmission and reception unit is configured to transmit the guide GUI information to the supported apparatus,
the supporting apparatus further comprises:
a request reception unit configured to determine a type of a mode based on information included in a support start request and, in the case where the type of the mode is determined as a first mode, cause the guide screen generation unit to generate the guide screen;
a process determination unit configured to cause the guide GUI generation unit to generate the guide GUI information, in the case where the type of the mode is determined as the first mode;
a substitute screen generation unit configured to generate a substitute screen which is an image corresponding to an operation screen in the supported apparatus, based on the operation screen information for specifying the one or more operation items displayed on the operation screen in the supported apparatus;
a substitute history generation unit configured to generate substitute operation history information which is history information of an operation performed by the supporting user on the substitute screen; and
a substitute operation execution unit configured to transmit an operation signal for operating an external operation target apparatus, to the operation target apparatus,
the request reception unit is configured to cause the substitute screen generation unit to generate the substitute screen, in the case where the type of the mode is determined as a second mode different from the first mode,
the process determination unit is configured to cause the substitute operation execution unit to transmit, to the operation target apparatus, the operation signal corresponding to the operation performed by the supporting user on the substitute screen, in the case where the type of the mode is determined as the second mode, and
the substitute operation execution unit is configured to cause the substitute history generation unit to generate the substitute operation history information and cause the transmission and reception unit to transmit the substitute operation history information to the supported apparatus, in the case where the type of the mode is determined as the second mode.

25. An inter-apparatus guide system in which a supported user who operates a supported apparatus to operate an operation target apparatus from the supported apparatus is supported by a supporting user through a supporting apparatus that is connected to the supported apparatus via a network, the inter-apparatus guide system comprising:
the supported apparatus according to claim 19; and
a supporting apparatus,
the supporting apparatus comprising:
a transmission and reception unit configured to receive operation screen information for specifying one or more operation items in the supported apparatus, from the supported apparatus;
a guide screen generation unit configured to generate a guide screen based on the operation screen information, the guide screen being an image including the one or more operation items;
an output unit configured to display the guide screen;
an input unit configured to obtain an operation performed by the supporting user on the guide screen; and
a guide GUI generation unit configured to generate guide graphical user interface (GUI) information indicating an operation item operated by the supporting user on the guide screen,
wherein the transmission and reception unit is configured to transmit the guide GUI information to the supported apparatus,
the supporting apparatus further comprises:
a request reception unit configured to determine a type of a mode based on information included in a support start request and, in the case where the type of the mode is determined as a first mode, cause the guide screen generation unit to generate the guide screen;
a process determination unit configured to cause the guide GUI generation unit to generate the guide GUI information, in the case where the type of the mode is determined as the first mode;
a substitute screen generation unit configured to generate a substitute screen which is an image corresponding to an operation screen in the supported apparatus, based on the operation screen information for specifying the one or more operation items displayed on the operation screen in the supported apparatus;
a substitute history generation unit configured to generate substitute operation history information which is history information of an operation performed by the supporting user on the substitute screen; and
a substitute operation execution unit configured to transmit an operation signal for operating an external operation target apparatus, to the operation target apparatus,
the request reception unit is configured to cause the substitute screen generation unit to generate the substitute screen, in the case where the type of the mode is determined as a second mode different from the first mode,
the process determination unit is configured to cause the substitute operation execution unit to transmit, to the operation target apparatus, the operation signal corresponding to the operation performed by the supporting user on the substitute screen, in the case where the type of the mode is determined as the second mode, and
the substitute operation execution unit is configured to cause the substitute history generation unit to generate the substitute operation history information and cause the transmission and reception unit to transmit the substitute operation history information to the supported apparatus, in the case where the type of the mode is determined as the second mode.

26. The inter-apparatus guide system according to claim 25,
wherein the information for specifying the one or more operation items is an identifier for identifying an image including each of the one or more operation items,
the output unit in the supported apparatus is configured to display a first image identified by the identifier from among one or more images held in the supported apparatus, on the operation screen as the image including the operation item, and
the output unit in the supporting apparatus is configured to display a second image identified by the identifier from among one or more images held in the supporting apparatus, on the guide screen as the image including the operation item.

27. A support reception method performed by a supported apparatus in an inter-apparatus guide system in which a supported user who operates the supported apparatus is supported by a supporting user through a supporting apparatus that is connected to the supported apparatus via a network, the support reception method comprising:
displaying an operation screen including one or more operation items, on the supported apparatus;
issuing a support start request which is a signal including operation screen information for specifying the one or more operation items displayed on the operation screen;
transmitting the support start request to the supporting apparatus;
receiving guide graphical user interface (GUI) information from the supporting apparatus, the guide GUI information indicating an operation item to be operated by the supported user from among the one or more operation items;
superimposing a guide GUI on the operation screen, the guide GUI being an image for showing the supported user the operation item indicated by the guide GUI information; and
receiving a support request from the supported user,
wherein the receiving of a support request includes determining a type of a mode of operation support designated by the supported user, when receiving the support request from the supported user,
the issuing includes issuing the support start request including the operation screen information and information indicating the determined type of the mode,
in the case where the type of the mode is determined as a first mode, the guide GUI is superimposed on the operation screen when receiving the guide GUI information, the operation screen on which the guide GUI is superimposed is displayed, and the supported apparatus operates according to an operation performed by the supported user on the operation screen,
the support reception method further comprises
recording substitute operation history information which is history information of an operation performed by the supporting user on the operation item displayed on the supporting apparatus, and
in the case where the type of the mode is determined as a second mode different from the first mode, the substitute operation history information obtained from the supporting apparatus and the operation screen are recorded in association with each other and, after a substitute operation by the supporting apparatus is performed, the recorded substitute operation history information is displayed in association with the operation screen.

28. A recording medium having recorded thereon a program for causing a computer to operate as a supported apparatus in an inter-apparatus guide system in which a supported user who operates the supported apparatus is supported by a supporting user through a supporting apparatus that is connected to the supported apparatus via a network, the program causing the computer to execute the support reception method according to claim 27.

29. An integrated circuit included in a supported apparatus in an inter-apparatus guide system in which a supported user who operates the supported apparatus is supported by a supporting user through a supporting apparatus that is connected to the supported apparatus via a network, the supported apparatus including an output unit configured to display an operation screen which is an image including one or more operation items, the integrated circuit comprising:
a request issuance unit configured to issue a support start request which is a signal including operation screen information for specifying the one or more operation items displayed on the operation screen;
a transmission and reception unit configured to transmit the support start request to the supporting apparatus, and receive guide graphical user interface (GUI) information from the supporting apparatus, the guide GUI information indicating an operation item to be operated by the supported user from among the one or more operation items;
a guide GUI superimposition unit configured to superimpose a guide GUI on the operation screen based on the guide GUI information, the guide GUI being an image for showing the supported user the operation item to be operated; and
a process determination unit configured to receive a support request from the supported user,
wherein the process determination unit is configured to determine a type of a mode of operation support designated by the supported user, when receiving the support request from the supported user,
the request issuance unit is configured to issue the support start request including the operation screen information and information indicating the determined type of the mode,
in the case where the type of the mode is determined as a first mode, the process determination unit is configured to cause the guide GUI superimposition unit to superimpose the guide GUI on the operation screen when the transmission and reception unit receives the guide GUI information, the output unit is configured to display the operation screen on which the guide GUI is superimposed, and the supported apparatus operates according to an operation performed by the supported user on the operation screen,
the integrated circuit further comprises
a substitute history recording unit configured to record substitute operation history information which is history information of an operation performed by the supporting user on the operation item displayed on the supporting apparatus, and
in the case where the type of the mode is determined as a second mode different from the first mode, the process determination unit is configured to cause the substitute history recording unit to record the substitute operation history information obtained from the supporting apparatus and the operation screen in association with each other, and the output unit is configured to, after a substitute operation by the supporting apparatus is performed, display the recorded substitute operation history information in association with the operation screen.

30. A supporting method performed by a supporting apparatus in an inter-apparatus guide system in which a supported user who operates a supported apparatus is supported by a supporting user through the supporting apparatus that is connected to the supported apparatus via a network, the supporting method comprising:
receiving operation screen information for specifying one or more operation items displayed on an operation screen in the supported apparatus, from the supported apparatus;
generating a guide screen based on the operation screen information, the guide screen being an operation screen corresponding to the operation screen in the supported apparatus;
displaying the guide screen;
obtaining an operation performed by the supporting user on the guide screen;
generating guide graphical user interface (GUI) information for specifying an operation item operated by the supporting user on the guide screen;
transmitting the guide GUI information to the supported apparatus;
determining a type of a mode based on information included in a support start request and, in the case where the type of the mode is determined as a first mode, generating the guide screen;
generating the guide GUI information, in the case where the type of the mode is determined as the first mode;
generating a substitute screen which is an image corresponding to the operation screen in the supported apparatus, based on the operation screen information for specifying the one or more operation items displayed on the operation screen in the supported apparatus;
generating substitute operation history information which is history information of an operation performed by the supporting user on the substitute screen; and
transmitting an operation signal for operating an external operation target apparatus, to the operation target apparatus,
wherein the generating of a substitute screen includes generating the substitute screen, in the case where the type of the mode is determined as a second mode different from the first mode,
the transmitting of an operation signal includes transmitting, to the operation target apparatus, the operation signal corresponding to the operation performed by the supporting user on the substitute screen, in the case where the type of the mode is determined as the second mode, and
the generating of substitute operation history information includes generating the substitute operation history information and transmitting the substitute operation history information to the supported apparatus, in the case where the type of the mode is determined as the second mode.

31. A recording medium having recorded thereon a program for causing a computer to operate as a supporting apparatus in an inter-apparatus guide system in which a supported user who operates a supported apparatus is supported by a supporting user through the supporting apparatus that is connected to the supported apparatus via a network, the program causing the computer to execute the supporting method according to claim 30.

32. An integrated circuit included in a supporting apparatus in an inter-apparatus guide system in which a supported user who operates a supported apparatus is supported by a supporting user through the supporting apparatus that is connected to the supported apparatus via a network, the supporting apparatus including: an output unit configured to display a guide screen; and an input unit configured to obtain an operation performed by the supporting user on the guide screen, the integrated circuit comprising:
a transmission and reception unit configured to receive operation screen information for specifying one or more operation items in the supported apparatus, from the supported apparatus;
a guide screen generation unit configured to generate the guide screen based on the operation screen information, the guide screen being an image including the one or more operation items; and
a guide GUI generation unit configured to generate guide graphical user interface (GUI) information indicating an operation item operated by the supporting user on the guide screen,
wherein the transmission and reception unit is configured to transmit the guide GUI information to the supported apparatus,
the integrated circuit further comprises:
a request reception unit configured to determine a type of a mode based on information included in a support start request and, in the case where the type of the mode is determined as a first mode, cause the guide screen generation unit to generate the guide screen;
a process determination unit configured to cause the guide GUI generation unit to generate the guide GUI information, in the case where the type of the mode is determined as the first mode;
a substitute screen generation unit configured to generate a substitute screen which is an image corresponding to an operation screen in the supported apparatus, based on the operation screen information for specifying the one or more operation items displayed on the operation screen in the supported apparatus;
a substitute history generation unit configured to generate substitute operation history information which is history information of an operation performed by the supporting user on the substitute screen; and
a substitute operation execution unit configured to transmit an operation signal for operating an external operation target apparatus, to the operation target apparatus,
the request reception unit is configured to cause the substitute screen generation unit to generate the substitute screen, in the case where the type of the mode is determined as a second mode different from the first mode,
the process determination unit is configured to cause the substitute operation execution unit to transmit, to the operation target apparatus, the operation signal corresponding to the operation performed by the supporting user on the substitute screen, in the case where the type of the mode is determined as the second mode, and
the substitute operation execution unit is configured to cause the substitute history generation unit to generate the substitute operation history information and cause the transmission and reception unit to transmit the substitute operation history information to the supported apparatus, in the case where the type of the mode is determined as the second mode.
